(19) United States
(12) Patent Application Publication
(10) Pub. No.: US 2016/0195756 A1
(43) Pub. Date: Jul. 7, 2016

(54) OPTICAL MODULATION DEVICE

(71) Applicant: SAMSUNG DISPLAY CO., LTD., Yongin-City (KR)

(72) Inventors: SOO HEE OH, Hwaseong-si (KR); YOON KYUNG PARK, Seoul (KR); HYUN SEUNG SEO, Anyang-si (KR)

(21) Appl. No.: 14/736,703

(22) Filed: Jun. 11, 2015

(30) Foreign Application Priority Data
Jan. 2, 2015 (KR) 10-2015-0000229

(51) Int. Cl. G02F 1/137; G02F 1/1337; G02F 1/1343; G02F 1/1333

(52) U.S. Cl. CPC G02F 1/13731; G02F 1/133345; G02F 1/1337; G02F 1/134309

(57) ABSTRACT

An optical modulation device includes a first plate, a second plate, and a liquid crystal layer. The first plate includes an active area and a peripheral area positioned around the active area. The liquid crystal layer is positioned between the first plate and the second plate and includes a plurality of liquid crystal molecules. The first plate includes a first electrode, first and second voltage transmitting lines, and a first aligner. The second plate includes a second electrode and a second aligner. The first and second voltage transmitting lines are positioned at the peripheral area and extend in a direction crossing a direction in which the first electrode extends. The first electrode is electrically connected to the first voltage transmitting line in the peripheral area. The first electrode includes a portion overlapping the second voltage transmitting line.

### CROSS-REFERENCE TO RELATED APPLICATION

This application claims priority under 35 U.S.C. §119 to Korean Patent Application No. 10-2015-0000229, filed on Jan. 2, 2015, in the Korean Intellectual Property Office, the disclosure of which is incorporated by reference herein in its entirety.

### TECHNICAL FIELD

The present invention relates to an optical modulation device, and more particularly, to an optical modulation device including liquid crystal molecules.

### DISCUSSION OF THE RELATED ART

Three-dimensional (3D) image display devices may employ an optical display device for dividing and outputting images at different viewpoints so that a viewer may recognize the images as stereoscopic images. The optical modulation device may include a lens or a prism to change a path of light of the image of the display device and direct the light to a desired viewpoint.

The path of light may be controlled using diffraction of the light due to phase modulation of the light in the optical modulation device.

### SUMMARY

According to an exemplary embodiment of the present invention, an optical modulation device is provided. The optical modulation device includes a first plate, a second plate, and a liquid crystal layer. The first plate includes an active area and a peripheral area positioned around the active area. The liquid crystal layer is positioned between the first plate and the second plate and includes a plurality of liquid crystal molecules. The first plate includes a first electrode, first and second voltage transmitting lines, and a first aligner. The second plate includes a second electrode and a second aligner. An alignment direction of the first aligner is substantially parallel to an alignment direction of the second aligner. The first and second voltage transmitting lines are positioned at the peripheral area and extend in a direction crossing a direction in which the first electrode extends. The first electrode is electrically connected to the first voltage transmitting line in the peripheral area. The first electrode includes a portion overlapping the second voltage transmitting line. The first voltage transmitting line is positioned between the second voltage transmitting line and the active area.

The first electrode may include a portion overlapping the first and second voltage transmitting lines in the peripheral area.

The optical modulation device may further include an insulating layer positioned between the first voltage transmitting line and the first electrode.

The insulating layer may include a contact hole exposing the first electrode.

When the first electrode and the second electrode are applied with at least one driving voltage, the optical modulation device may form a plurality of unit areas. A phase change of the liquid crystal layer may be periodically generated by a unit of the unit area. An interval between the first and second voltage transmitting lines may be equal to or more than about substantially 80% of a pitch of the unit area.

The first voltage transmitting line may include an expansion, and the first electrode may be connected to the expansion through the contact hole.

When no electric field is generated to the liquid crystal layer, a pretilt direction of the liquid crystal molecules adjacent to the first plate may be opposite to a pretilt direction of the liquid crystal molecules adjacent to the second plate.

The plurality of unit areas may include a first unit area and a second unit area. When an electric field is generated to the liquid crystal layer, intensity of the electric field in an area adjacent to the first electrode may be greater than intensity of the electric field in an area adjacent to the second electrode in a portion of the liquid crystal layer corresponding to the first electrode in the first unit area.

Intensity of the electric field in an area adjacent to the first plate may be smaller than intensity of the electric field in an area adjacent to the second plate in a portion of the liquid crystal layer corresponding to the second unit area adjacent to the first unit area.

The plurality of unit areas may include a first unit area and a second unit area adjacent to the first unit area. The first unit area may include the first electrode in the first plate. The second unit area may include a third electrode in the first plate.

A voltage applied to the first electrode included in the first unit area may be greater than a voltage applied to the third electrode included in the second unit area.

According to an exemplary embodiment of the present invention, an optical modulation device is provided. The optical modulation device includes a first plate, a second plate, and a liquid crystal layer. The first plate includes an active area and a peripheral area positioned around the active area. The liquid crystal layer is positioned between the first plate and the second plate and includes a plurality of liquid crystal molecules. The first plate includes a first electrode, first and second voltage transmitting lines, and a first aligner. The second plate includes a second electrode and a second aligner. An alignment direction of the first aligner is substantially parallel to an alignment direction of the second aligner. The first and second voltage transmitting lines are positioned at the peripheral area and extend in a direction crossing a direction in which the first electrode extends. The first electrode is electrically connected to the first voltage transmitting line in the peripheral area. When a driving voltage is applied to the first electrode and the second electrode, the optical modulation device forms a plurality of unit areas, a phase change of the liquid crystal layer is periodically generated by a unit of the unit area, and an interval between the first and second voltage transmitting lines is equal to or more than substantially 80% of a pitch of the unit areas.

According to an exemplary embodiment of the present invention, an optical modulation device is provided. The optical modulation device includes a first plate, a second plate, and a liquid crystal layer. The first plate includes an active area and a peripheral area positioned around the active area. The liquid crystal layer is positioned between the first plate and the second plate. The liquid crystal layer includes a plurality of liquid crystal molecules. The first plate includes a first electrode and first and second voltage transmitting lines. The second plate includes a second electrode. The first and second voltage transmitting lines extend in a first direction crossing a second direction in which the first electrode extends. The first and second voltage transmitting lines are substantially parallel to each other. The optical modulation device forms a plurality of unit areas when the first electrode and the second electrode are applied with at least one driving voltage. A width of each of the first and second voltage transmitting lines depends on a pitch of the unit area. The first electrode is electrically connected to the first voltage transmitting line in the peripheral area.

The first electrode may include a portion overlapping the second voltage transmitting line. The first voltage transmitting line may be positioned between the second voltage transmitting line and the active area.

The width of each of the first and second voltage transmitting lines may be decreased as the pitch of the unit area is increased.

An interval between the first and second voltage transmitting lines may be equal to or more than substantially 80% of the pitch of the unit area.

### BRIEF DESCRIPTION OF THE DRAWINGS

A more complete appreciation of the present invention and many of the attendant aspects thereof will be readily obtained as the same becomes better understood by reference to the following detailed description when considered in connection with the accompanying drawings, wherein:

FIG. 1 is an exploded perspective view of an electronic device including an optical modulation device according to an exemplary embodiment of the present invention;

FIG. 2 is a perspective view of an active area of an optical modulation device according to an exemplary embodiment of the present invention;

FIG. 3 is a plan view showing an alignment direction in a first plate and a second plate included in an optical modulation device according to an exemplary embodiment of the present invention;

FIG. 4 is a view showing a process of assembling the first plate and the second plate shown in FIG. 3 according to an exemplary embodiment of the present invention;

FIG. 5 is a perspective view showing an arrangement of liquid crystal molecules when no voltage difference is applied between a first plate and a second plate of an optical modulation device according to an exemplary embodiment of the present invention;

FIG. 6 is a cross-sectional view of the optical modulation device shown in FIG. 5, which is taken along planes I, II, and III, according to an exemplary embodiment of the present invention;

FIG. 7 is a perspective view showing an arrangement of liquid crystal molecules in an active area when a voltage difference is applied between a first plate and a second plate of an optical modulation device according to an exemplary embodiment of the present invention;

FIG. 8 is a cross-sectional view of the optical modulation device shown in FIG. 7, which is taken along planes I, II, and III, according to an exemplary embodiment of the present invention;

FIG. 9 is a perspective view of an active area of an optical modulation device according to an exemplary embodiment of the present invention;

FIG. 10 is a timing diagram of a driving signal of an optical modulation device according to an exemplary embodiment of the present invention;

FIG. 11(a) is a cross-sectional view showing an arrangement of liquid crystal molecules, which is taken along a plane IV of FIG. 9, before a voltage difference is applied between a first plate and a second plate of an optical modulation device according to an exemplary embodiment of the present invention;

FIG. 11(b) is a cross-sectional view showing an arrangement of liquid crystal molecules, which is taken along a plane IV of FIG. 9, after a first-step driving signal is applied between a first plate and a second plate of an optical modulation device according to an exemplary embodiment of the present invention;

FIG. 12 is a cross-sectional view showing an arrangement of liquid crystal molecules that are stabilized after a first-step driving signal is applied to an optical modulation device according to an exemplary embodiment of the present invention, which is taken along a plane V of FIG. 9, and shows a graph illustrating a phase change corresponding thereto;

FIG. 13 are cross-sectional views showing an arrangement of liquid crystal molecules before a voltage difference is applied between a first plate and a second plate of an optical modulation device according to an exemplary embodiment of the present invention, which are taken along planes IV and V of FIG. 9;

FIG. 14 is a cross-sectional view showing an arrangement of liquid crystal molecules right after a first-step driving signal is applied to an optical modulation device according to an exemplary embodiment of the present invention, which is taken along a plane IV of FIG. 9;

FIG. 15 is a cross-sectional view showing an arrangement of liquid crystal molecules before being stabilized after a first-step driving signal is applied to an optical modulation device according to an exemplary embodiment of the present invention, which is taken along a plane IV shown in FIG. 9;

FIG. 16 are cross-sectional views showing an arrangement of liquid crystal molecules that are stabilized after a first-step driving signal is applied to an optical modulation device according to an exemplary embodiment of the present invention, which are taken along planes IV and V shown in FIG. 9;

FIG. 17 are cross-sectional views showing an arrangement of liquid crystal molecules before a voltage difference is applied between a first plate and a second plate of an optical modulation device according to an exemplary embodiment of the present invention and after each of first-step to third-step driving signals is applied, which are taken along a plane IV of FIG. 9;

FIG. 18 is a cross-sectional view showing an arrangement of liquid crystal molecules that are stabilized after first-step to third-step driving signals are sequentially applied to an optical modulation device according to an exemplary embodiment of the present invention, which is taken along a plane V of FIG. 9, and shows a graph illustrating a phase change corresponding thereto;

FIG. 19 is a view showing a phase change depending on a position of a lens realized by using an optical modulation device according to an exemplary embodiment of the present invention;

FIG. 20 is a layout view showing a peripheral area of an optical modulation device according to an exemplary embodiment of the present invention;

FIG. 21 is a cross-sectional view of a peripheral area of an optical modulation device shown in FIG. 20, which is taken along a line XXI-XXI according to an exemplary embodiment of the present invention;

FIGS. 22(a) to 22(c) are layout views sequentially showing a change of an abnormal area depending on a time in which an arrangement of liquid crystal molecules generated at a peripheral area is scattered when a driving signal is applied to an optical modulation device according to an exemplary embodiment of the present invention;

FIG. 23 is a layout view showing a peripheral area of an optical modulation device according to an exemplary embodiment of the present invention;

FIG. 24 is an enlarged layout view of a portion of the peripheral area of the optical modulation device shown in FIG. 23 according to an exemplary embodiment of the present invention;

FIGS. 25(a) and 25(b) are plan views sequentially showing a change of an abnormal area depending on a time in which an arrangement of liquid crystal molecules generated at a peripheral area is scattered when a driving signal is applied to an optical modulation device according to an exemplary embodiment of the present invention; and

FIG. 26 is a block diagram illustrating an optical modulation device and a driver connected to the optical modulation device according to an exemplary embodiment of the present invention.

### DETAILED DESCRIPTION OF THE EMBODIMENTS

Exemplary embodiments of the present invention will be described more fully hereinafter with reference to the accompanying drawings, in which exemplary embodiments of the invention are shown. The present invention may be modified in various forms without departing from the spirit or scope of the present invention and should not be construed as being limited to the exemplary embodiments set forth herein.

In the drawings, thickness of layers, films, panels, areas, etc., may be exaggerated for clarity. Like reference numerals may designate like elements throughout the specification.

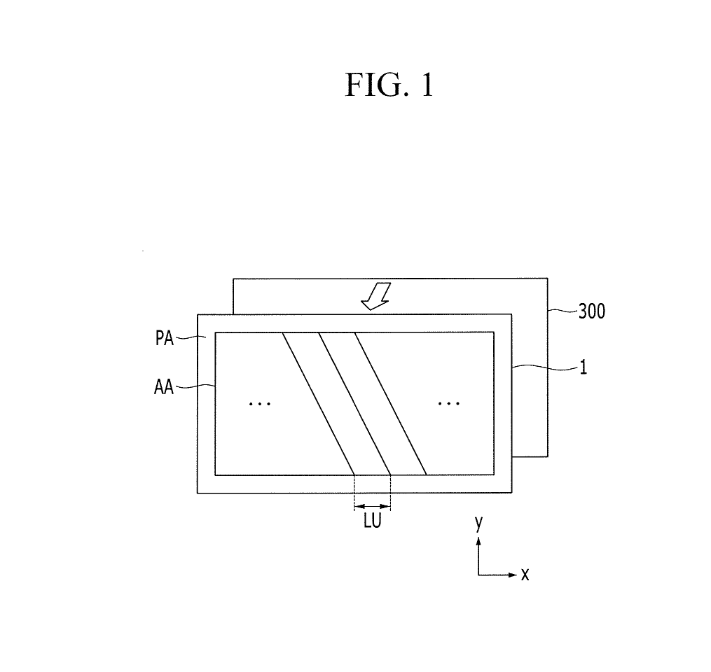

Hereinafter, an optical modulation device and an electronic device according to an exemplary embodiment of the present invention will be described with reference to FIG. 1.

FIG. 1 is an exploded perspective view of an electronic device including an optical modulation device according to an exemplary embodiment of the present invention.

Referring to FIG. 1, the electronic device, which may be considered as a stereoscopic image display device, may include a display panel 300 and an optical modulation device 1.

The display panel 300 may display a two-dimensional (2D) image in a 2D mode, and may divide the image corresponding to different viewing points by spatial division or temporal division to alternately display the same by a position or a time in a three-dimensional (3D) mode. For example, in the 3D mode, some pixels among a plurality of pixels may display an image corresponding to one of the different viewing points, and the other pixels may display the image corresponding to another one of the different viewing points. A number of viewing points may be two or more.

The display panel 300 may be an organic light emitting panel including an organic light emitting element, a liquid crystal panel including a liquid crystal layer, or the like.

The optical modulation device 1 is positioned in front of the display panel 300, and includes an active area AA that transmits light and a peripheral area PA positioned around the active area AA. When a driving signal is applied to the optical modulation device 1, the active area AA of the optical modulation device 1 generates different phase retardations depending on positions, and thus, the active area AA functions an optical device such as a prism, a lens, or the like. Accordingly, when the driving signal is applied to the optical modulation device 1, a progressing direction of the light passing through the active area AA may be changed.

FIG. 1 shows an example in which the active area AA of the optical modulation device 1 forms a plurality of lenses LU. The lenses LU are arranged in a substantially x-axis direction, and a center axis of each lens LU or a boundary between the lenses LU may be inclined with an inclination angle with respect to a y-axis substantially perpendicular to the x-axis.

As described above, when the optical modulation device 1 forms a plurality of lenses LU and the display panel 300 displays the 3D image, the optical modulation device 1 may divide the 3D image into a plurality of viewing points to output the same, and thus, a viewer having eyes on different viewing points may observe a stereoscopic image or viewers of the different viewing points may observe different images from each other.

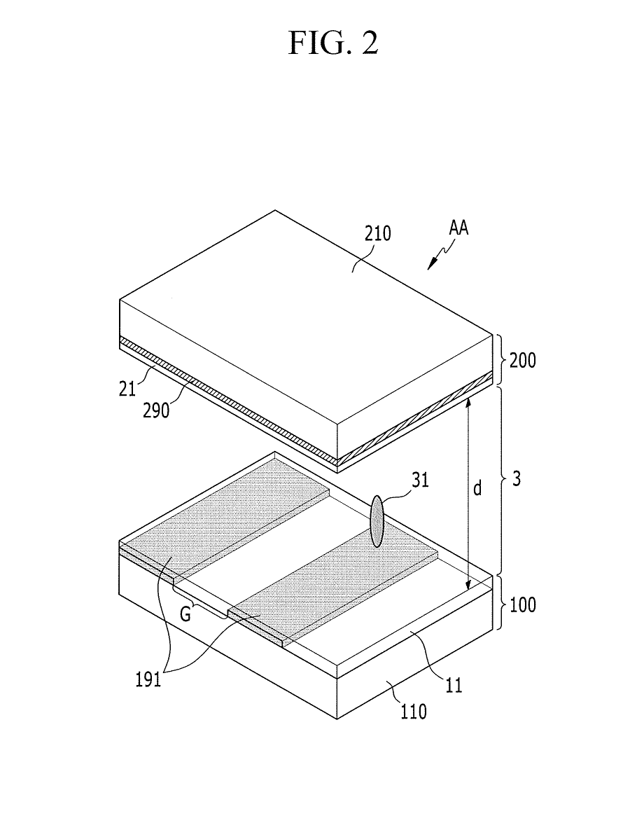

In addition, the optical modulation device 1 according to an exemplary embodiment of the present invention will be described with reference to FIG. 2 to FIG. 4.

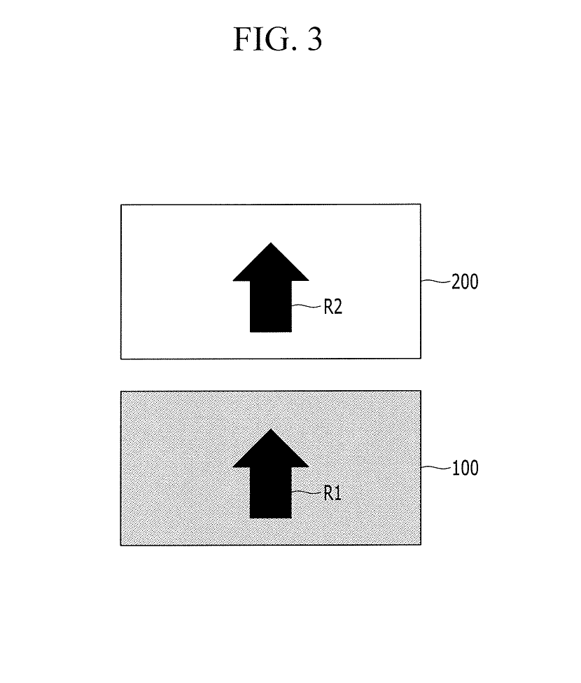

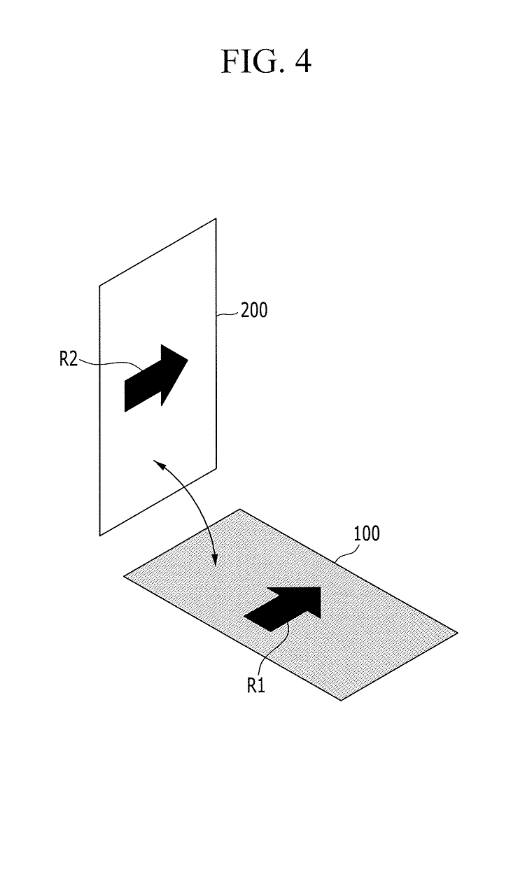

FIG. 2 is a perspective view of an active area of an optical modulation device according to an exemplary embodiment of the present invention, FIG. 3 is a plan view showing an alignment direction in a first plate and a second plate included in an optical modulation device according to an exemplary embodiment of the present invention, and FIG. 4 is a view showing a process of assembling the first plate and the second plate shown in FIG. 3 according to an exemplary embodiment of the present invention.

Referring to FIG. 3, the optical modulation device 1 according to an exemplary embodiment of the present invention includes a first plate 100 and a second plate 200 opposite to the first plate 100, and a liquid crystal layer 3 interposed between the first and second plates 100 and 200.

The first plate 100 may include a first substrate 110 that may be made of glass, plastic, or the like. The first substrate 110 may be rigid or flexible, and may be flat or bent at least in part.

A plurality of lower electrodes 191 are formed on the first substrate 110. Each lower electrode 191 includes a conductive material, and may include a transparent conductive material such as ITO, IZO, or the like, or a metal. The lower electrode 191 may be applied with a voltage from a voltage supply unit, and lower electrodes 191 that are adjacent to each other or different from each other may be applied with different voltages.

The plurality of lower electrodes 191 may be arranged in a predetermined direction, for example, the x-axis direction, and each lower electrode 191 may be elongated in a direction crossing the x-axis direction. For example, each lower electrode 191 may be elongated with a predetermined angle with respect to the y-axis direction.

A width of a space G between the adjacent lower electrodes 191 may be variously controlled depending on design conditions of the optical modulation device. A ratio of a width of the lower electrode 191 and a width of the space G adjacent thereto may be substantially N:1 (where N is a real number that is greater than 1), for example the width of the lower electrode 191 may be greater than the width of the space G adjacent thereto.

The second plate 200 may include a second substrate 210 that may be formed of glass, plastic, or the like. The second substrate 210 may be rigid or flexible, and may be flat or bent at least in part.

An upper electrode 290 is positioned on the second substrate 210. The upper electrode 290 includes a conductive material, and may include a transparent conductive material such as ITO, IZO, or the like, or a metal. The upper electrode 290 may be applied with a voltage from a voltage supply unit. The upper electrode 290 may be formed of a whole body on the second substrate 210, or may be patterned to include a plurality of separated portions.

The liquid crystal layer 3 includes a plurality of liquid crystal molecules 31. The liquid crystal molecules 31 have negative dielectric anisotropy such that they may be arranged in a transverse direction with respect to a direction of an electric field generated in the liquid crystal layer 3. The liquid crystal molecules 31 may be aligned in a substantially vertical direction with respect to the second plate 200 and the first plate 100 and may be pre-tilted in a predetermined direction when no electric field is generated to the liquid crystal layer 3. The liquid crystal molecules 31 may be nematic liquid crystal molecules.

A height d of a cell gap of the liquid crystal layer 3 may substantially satisfy Equation 1 for light of a predetermined wavelength (λ). Accordingly, the active area AA of the optical modulation device according to an exemplary embodiment of the present invention may function as an approximate half-wave plate, and may be used as a diffraction lattice, a lens, or the like.

$$\frac{λ}{2} \times 1.3 \geq Δ nd \geq \frac{λ}{2} \qquad ( Equation 1 )$$

In Equation 1, Δnd is a phase delay value of the light passing through the liquid crystal layer 3.

A first aligner 11 is positioned at an inner surface of the first plate 100, and a second aligner 21 is positioned at an inner surface of the second plate 200. The first aligner 11 and the second aligner 21 may be vertical alignment layers and may have an alignment force formed by various methods such as a rubbing process, a photoalignment process, or the like, to determine a pretilt direction of the liquid crystal molecules 31 adjacent to the first plate 100 and the second plate 200. In the case of using the rubbing process, the vertical alignment layer (e.g., the first aligner 11 or the second aligner 21) may be an organic vertical alignment layer. In the case of using the photoalignment process, an alignment material including a photosensitive polymer material is coated on inner surfaces of the first plate 100 and second plate 200 and is irradiated with light such as ultraviolet rays, or the like, to form a photo-polymerization material.

Referring to FIG. 4, respective alignment directions R1 and R2 of two aligners 11 and 21 positioned at the inner surfaces of the first plate 100 and the second plate 200 may be substantially parallel to each other. In addition, the alignment directions R1 and R2 of the aligners 11 and 21 are constant.

When considering a misalignment margin of the first plate 100 and the second plate 200, a difference between an azimuth angle of the first aligner 11 of the first plate 100 and an azimuth angle of the second aligner 21 of the second plate 200 may be substantially±5 degrees, but is not limited thereto.

Referring to FIG. 4, the optical modulation device 1 according to an exemplary embodiment of the present invention may be formed by arranging the first plate 100 and the second plate 200 and by assembling the same. The aligners 11 and 21 substantially aligned in parallel to each other are formed, respectively, in the first and second plates 100 and 200.

For example, positions of the first plate 100 and the second plate 200 may be interchanged in a vertical direction.

As described above, according to an exemplary embodiment of the present invention, the aligners 11 and 21 formed, respectively, in the first plate 100 and the second plate 200 of the optical modulation device are parallel to each other, and each of the alignment directions R1 and R2 of the aligners 11 and 21 is constant, and thus an alignment process and a manufacturing process of the optical modulation device may be simplified. Accordingly, a failure of an optical modulation device or an electronic device including the optical modulation device due to the alignment failure may be prevented. Therefore, a large-sized optical modulation device may be produced.

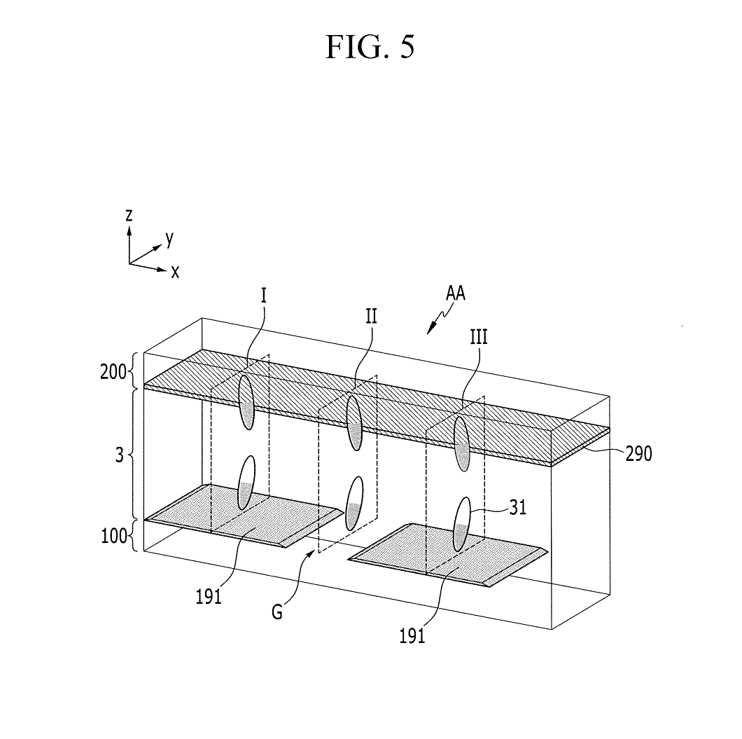

In addition, an operation of an optical modulation device according to an exemplary embodiment of the present invention will be described with reference to FIG. 5 to FIG. 8 along with FIG. 2 to FIG. 4.

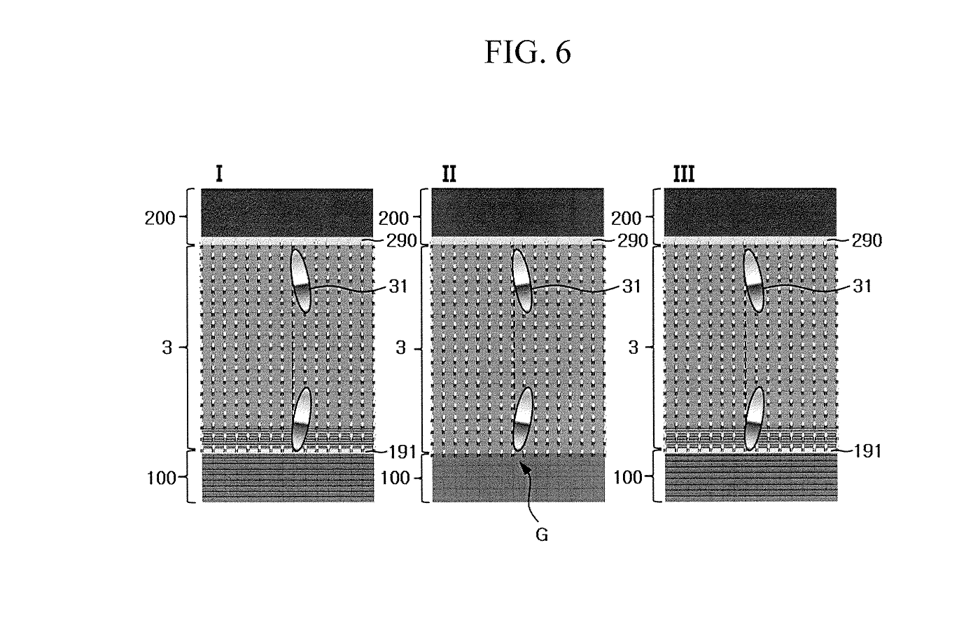

Referring to FIG. 5, when no voltage difference is provided between the lower electrode 191 of the first plate 100 and the upper electrode 290 of the second plate 200, no electric field is generated to the liquid crystal layer 3, the liquid crystal molecules 31 are arranged while having an initial pretilt angle. Referring to FIG. 6, the plane I corresponds to a first lower electrode 191 among a plurality of lower electrodes 191 positioned at the active area AA of the optical modulation device shown in FIG. 5, the plane III corresponds to a second lower electrode 191 among the plurality of lower electrodes 191 adjacent to the first lower electrode 191, and the plane II corresponds to a space G between the first and second lower electrodes 191 adjacent to each other. Referring to FIG. 6, an arrangement of the liquid crystal molecules 31 may be substantially constant.

Although, in FIG. 6, some of the liquid crystal molecules 31 are illustrated as penetrating a region of the first plate 100 or the second plate 200, this is for convenience of explanation and the liquid crystal molecules 31 might not penetrate the region of the first plate 100 or the second plate 200, and the same will be applied to the rest of drawings.

The liquid crystal molecules 31 adjacent to the first plate 100 are initially aligned (e.g., pre-tilted) along a first direction substantially parallel to an alignment direction of the aligner 11, and the liquid crystal molecules 31 adjacent to the second plate 200 may be initially aligned (e.g., pre-tiled) in a second direction substantially parallel with an alignment direction of the second aligner 21. Thus, a pre-tilted direction of the liquid crystal molecules 31 adjacent to the first plate 100 and a pre-tilted direction of the liquid crystal molecules 31 adjacent to the second plate 200 might not be parallel to each other and may be opposite to each other. For example, the liquid crystal molecules 31 adjacent to the first plate 100 and the liquid crystal molecules 31 adjacent to the second plate 200 may be inclined to be symmetrical to each other with reference to a transverse center line extending transversely along the center of the liquid crystal layer 3. For example, when the liquid crystal molecules 31 adjacent to the first plate 100 are inclined rightward with reference to the transverse center line in the cross-sectional view, the liquid crystal molecules 31 adjacent to the second plate 200 may be inclined leftward with reference to the transverse center line in the cross-sectional view.

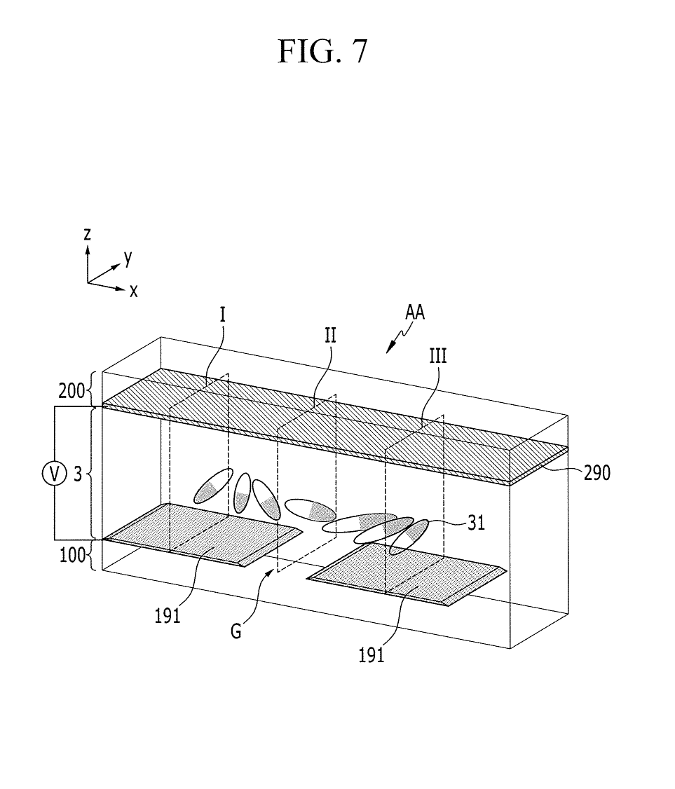

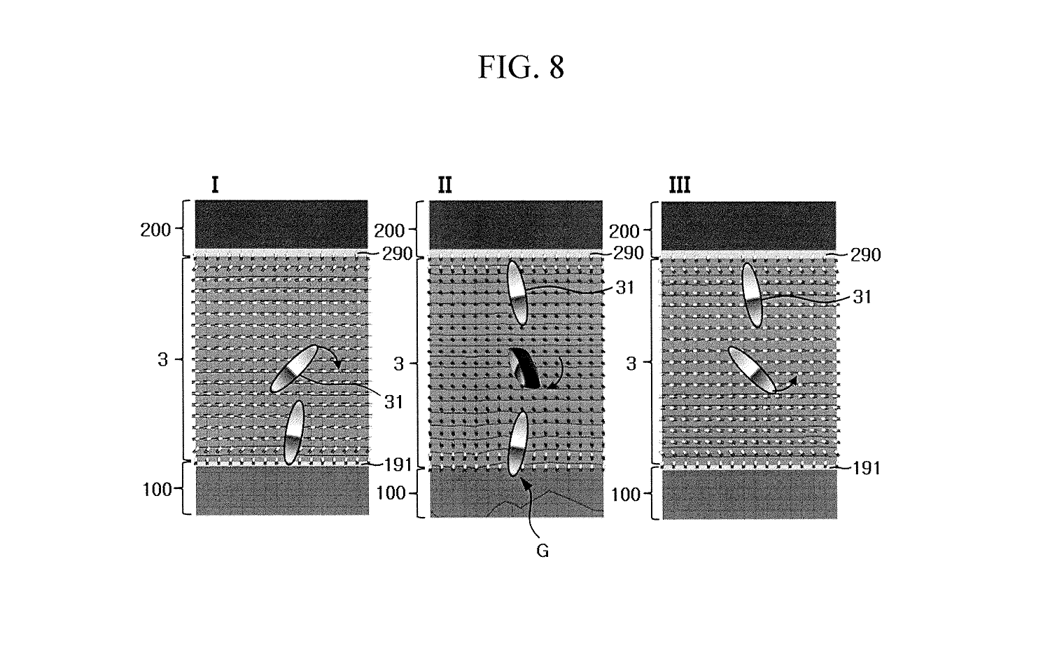

Referring to FIG. 7 and FIG. 8, a voltage difference of more than the threshold voltage is applied between the lower electrode 191 of the first plate 100 and the upper electrode 290 of the second plate 200 such that the liquid crystal molecules 31 having negative dielectric anisotropy tend to be inclined in a direction that is substantially perpendicular to a direction of the electric field after the electric field is generated in the liquid crystal layer 3. Accordingly, as shown in FIG. 7 and FIG. 8, the liquid crystal molecules 31 are mainly inclined to be substantially parallel to the surface of the first plate 100 or the second plate 200 to form an in-plane arrangement, and the long axes of the liquid crystal molecules 31 are rotated and arranged in an in-plane manner (e.g., in a plan view). The in-plane arrangement may be understood to mean that the long axis of the liquid crystal molecules 31 is arranged to be substantially parallel to the surface of the first plate 100 or the second plate 200.

In this case, a rotation angle (e.g., an azimuthal angle) on the in-plane of the liquid crystal molecules 31 may be changed depending on a voltage applied between the lower electrode 191 and the upper electrode 290. For example, the rotation angle of the liquid crystal molecules 31 may be changed in a spiral shape along a position of the x-axis direction.

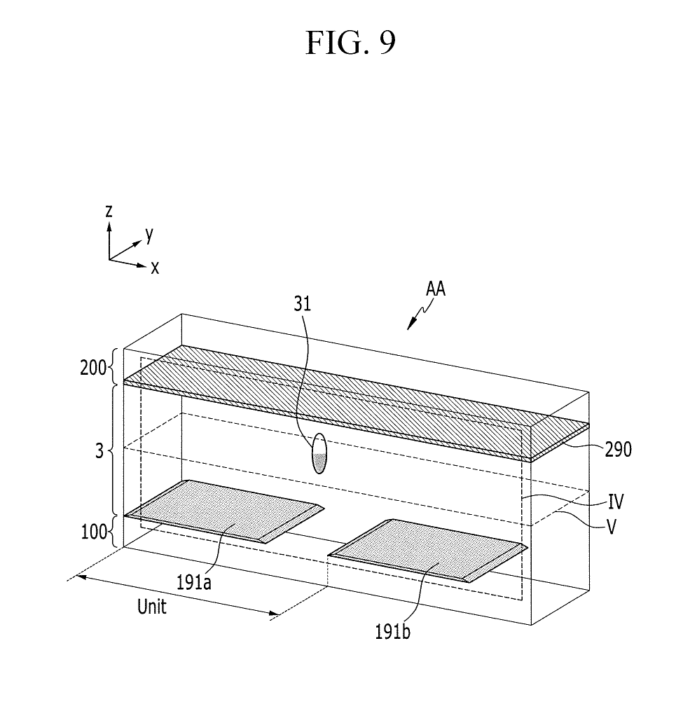

Next, a driving method and an operation of an optical modulation device according to an exemplary embodiment of the present invention will be described with reference to FIG. 9 to FIG. 12 along with the previously described drawings.

FIG. 9 is a perspective view of an active area of an optical modulation device according to an exemplary embodiment of the present invention. The optical modulation device may have substantially the same structure as the above-described exemplary embodiment. The optical modulation device may include a plurality of unit areas Unit, and each of the unit areas Unit may include at least one lower electrode 191. In the present exemplary embodiment, each unit area includes one lower electrode 191, and two lower electrodes 191a and 191b positioned in two adjacent unit areas, respectively, will now be described. The two lower electrodes 191a and 191b will be referred to as a first electrode 191a and a second electrode 191b, respectively.

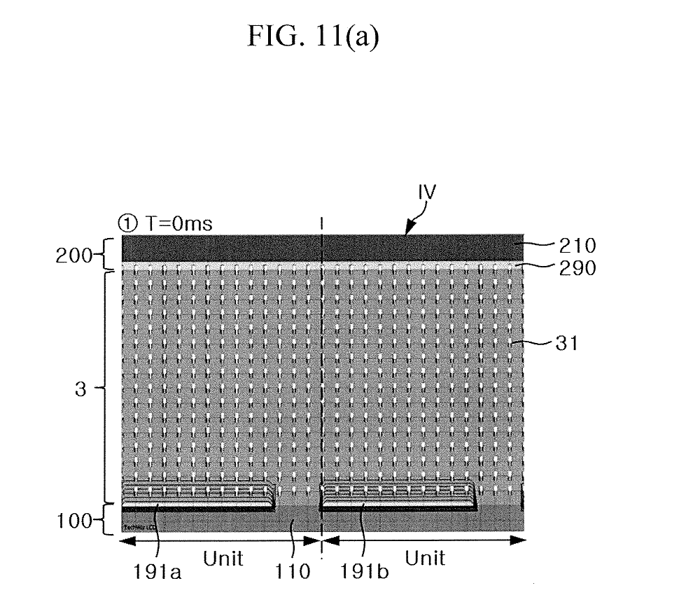

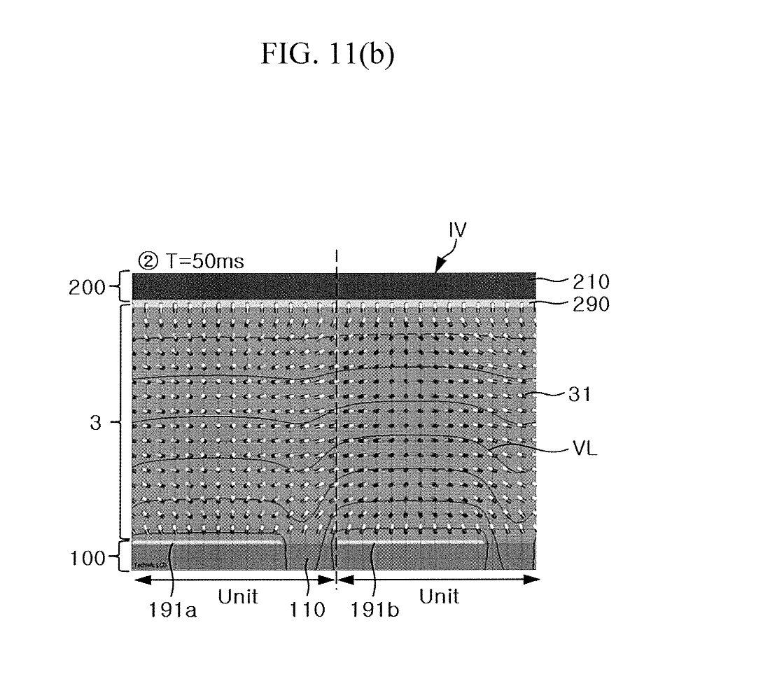

Referring to FIG. 11(a), when no voltage is applied to the first and second electrodes 191a and 191b and the upper electrode 290, the liquid crystal molecules 31 are initially aligned in a direction substantially vertical to planes of the first plate 100 and the second plate 200, and the liquid crystal molecules 31 may be pretilted in the alignment direction of the first plate 100 and the second plate 200 as described. In this case, the first and second electrodes 191a and 191b may be applied with a voltage of 0 V with reference to the voltage of the upper electrode 290 or may be applied with a voltage equal to or less than a threshold voltage Vth at which the alignment of the liquid crystal molecules 31 starts to be changed.

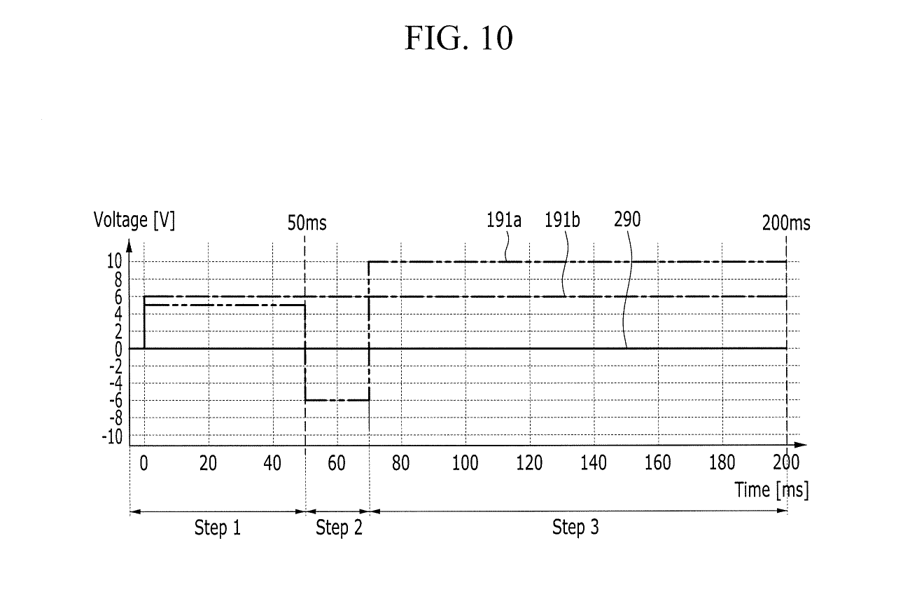

Referring to FIG. 10, to form a forward phase slope through the optical modulation device according to an exemplary embodiment of the present invention, the adjacent lower electrodes 191a and 191b and the upper electrode 290 may be applied with a first-step driving signal during one frame. In the first step (step 1), a voltage difference is formed between the lower electrode 191a and 191b of the first plate 100 and the upper electrode 290 of the second plate 200 and a voltage difference is formed between the adjacent first electrode 191a and second electrode 191b. For example, an absolute value of a second voltage applied to the second electrode 191b may be larger than an absolute value of a first voltage applied to the first electrode 191a. Also, a third voltage applied to the upper electrode 290 is different from the first voltage and the second voltage applied to the lower electrodes 191a and 191b. For example, an absolute value of the third voltage applied to the upper electrode 290 may be less than the absolute values of the first voltage and the second voltage applied to the first and second electrodes 191a and 191b, respectively. For example, the first electrode 191a may be applied with 5 V, the second electrode 191b may be applied with 6 V, and the upper electrode 290 may be applied with 0 V.

In an exemplary embodiment of the present invention, each unit area Unit may include a plurality of lower electrodes 191. In this case, the plurality of lower electrodes 191 of each unit area Unit may be applied with substantially the same voltages, or voltages that sequentially change by a unit of at least one lower electrode 191 may be applied to the plurality of lower electrodes 191 in each unit area Unit. For example, lower electrodes 191 of one unit area Unit of the adjacent unit areas Unit may be applied with voltages that are gradually increased by the unit of at least one lower electrode 191, and lower electrode 191 of another unit area Unit may be applied with voltages that are gradually decreased by the unit of at least one lower electrode 191.

Voltages applied to the lower electrodes 191 of each unit area Unit may have same polarities as positive polarities or negative polarities with reference to the voltage of the upper electrode 290. In addition, the polarities of the voltages applied to the lower electrodes 191 may be reversed by a unit of at least one frame.

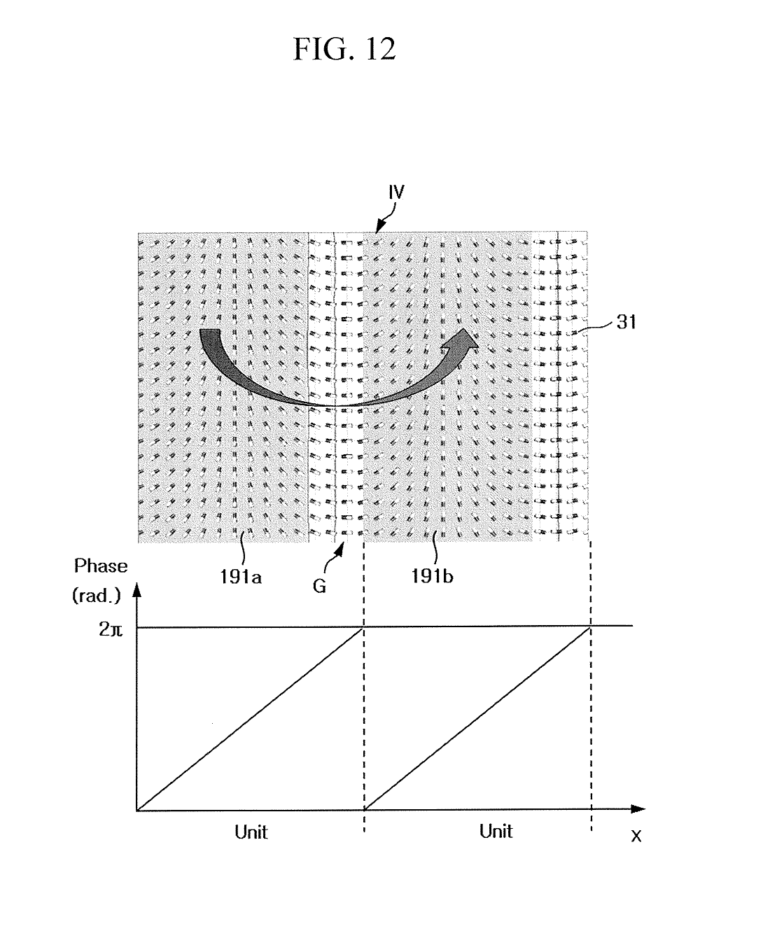

Thus, as shown in FIG. 11(b) and FIG. 12, the liquid crystal molecules 31 are rearranged according to an electric field generated in the liquid crystal layer 3. For example, the liquid crystal molecules 31 are mainly inclined to be substantially parallel to the surface of the first plate 100 or the second plate 200 to form an in-plane arrangement. For example, the long axes of the liquid crystal molecules 31 are rotated in an in-plane manner such that a spiral arrangement is formed as shown in FIG. 12, and thus, a “u”-shaped arrangement may be formed. Azimuthal angles of the long axes of the liquid crystal molecules 31 may be changed substantially from 0° to 180° on a cycle of a pitch of the lower electrode 191. A portion where the azimuthal angles of the long axes of the liquid crystal molecules 31 are changed substantially from 0° to 180° may form a u-shaped arrangement of the liquid crystal molecules 31.

A predetermined time may be taken until the arrangement of the liquid crystal molecules 31 is stabilized after the optical modulation device is applied with a first-step driving signal, and the optical modulation device forming the forward phase slope may be continually applied with the first-step driving signal.

Referring to FIG. 12, a region where the liquid crystal molecules 31 are rotated by 180 degrees in the x-axis direction is defined as one unit area Unit. In the present exemplary embodiment, one unit area Unit may include a space G between the first electrode 191a and the second electrode 191b adjacent to the first electrode 191a.

As described above, when the optical modulation device satisfies Equation 1 and substantially acts as a half-wavelength plate, a rotation direction of a circularly-polarized light, which is incident to the optical modulation device, may be reversely changed. FIG. 12 shows a phase change depending on a position of the x-axis direction when a right-circularly-polarized light is incident to the optical modulation device. The right-circularly-polarized light passing through the active area AA of the optical modulation device may be changed into the left-circularly-polarized light. Since a phase retardation value of the liquid crystal layer 3 varies in the x-axis direction, a phase of the emitted circularly-polarized light may continuously be changed.

When an optical axis of the optical modulation device 1 acting as a half-wavelength plate is rotated by φ degrees on the in-plane, a phase of the light passing through the half-wavelength plate is changed by 2φ degrees. Thus, as shown in FIG. 12, a phase of the light emitted from one unit area Unit of the optical modulation device is changed from 0 to 2π radians in the x-axial direction. This is referred to as a forward phase slope. The one unit area may be an area in which the azimuthal angles of the long axes of the liquid crystal molecules 31 are changed by 180 degrees. The phase change may be repeated every unit area Unit, and thus, a forward phase slope portion of a lens changing a direction of light may be implemented by using the optical modulation device.

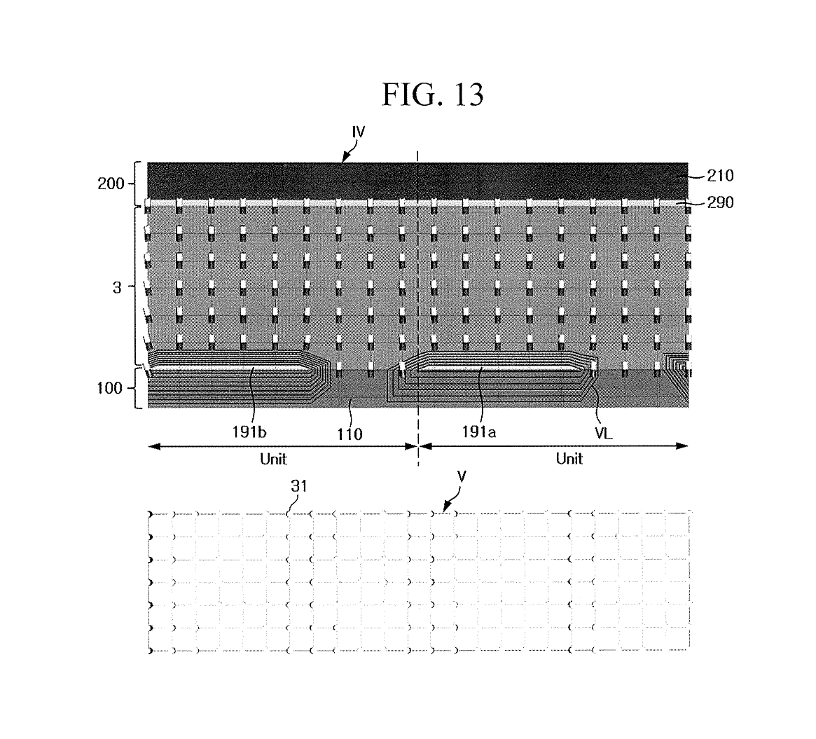

A method for realizing an optical modulation device as a forward phase slope as shown in FIG. 12 according to an exemplary embodiment of the present invention will be described with reference to FIG. 13 to FIG. 16 along with the above-described drawings.

FIG. 13 are cross-sectional views showing an arrangement of liquid crystal molecules 31 before a voltage difference is applied between first and second electrodes 191a and 191b of a first plate 100 and an upper electrode 290 of a second plate 100 of an optical modulation device according to an exemplary embodiment of the present invention, which are taken along planes IV and V of FIG. 9. FIG. 13 to FIG. 16 show a portion that moves in the horizontal direction by one unit area from the above-described drawings.

The liquid crystal molecules 31 are initially aligned in a direction substantially perpendicular to the surfaces of the first plate 100 and the second plate 200, and the liquid crystal molecules 31 may be pretilted along the respective alignment directions R1 and R2 of the first plate 100 and the second plate 200. Equipotential lines VL in the liquid crystal layer 3 are shown.

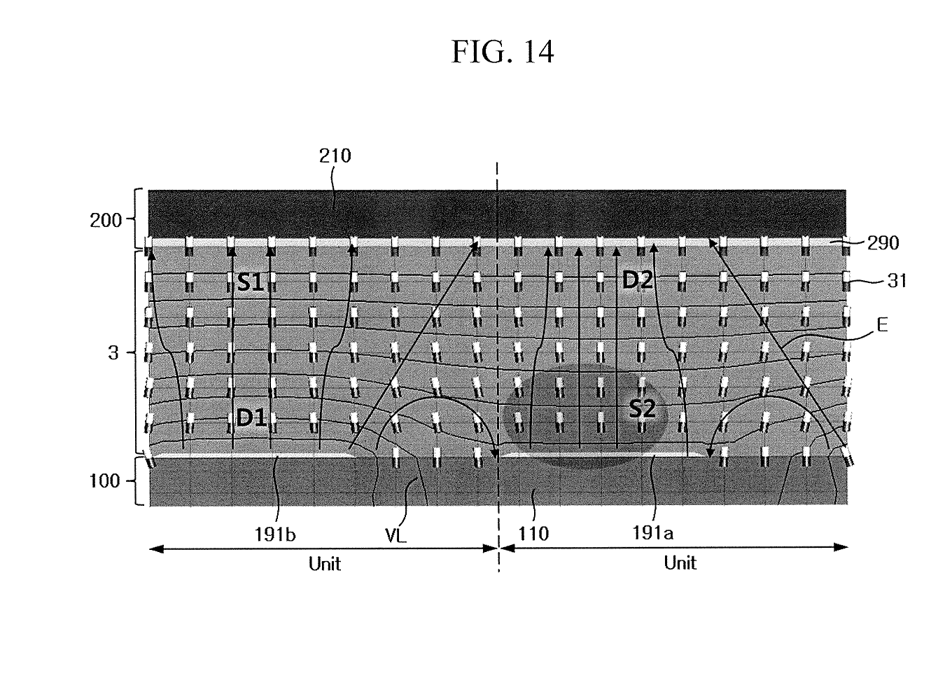

FIG. 14 is a cross-sectional view showing an arrangement of liquid crystal molecules 31 right after a first-step driving signal is applied to an optical modulation device according to an exemplary embodiment of the present invention, which is taken along a plane IV of FIG. 9. For example, the first-step driving signal may be applied between the first and second electrodes 191a and 191b of the first plate 100 and the upper electrode 290 of the second plate 200. An electric field E is generated in the liquid crystal layer 3, and equipotential lines VL according thereto are shown. For example, since the first and second electrodes 191a and 191b have edge sides, as shown in FIG. 14, and thus, a fringe field may be formed between each of the edge sides of the first and second electrodes 191a and 191b and the upper electrode 290.

When the first-step driving signal is applied to the first and second electrodes 191a and 191b and the upper electrode 290, intensity of an electric field in a region D1 adjacent to the first plate 100 is greater than intensity of an electric field in a region S1 adjacent to the second plate 200 in a liquid crystal layer 3 corresponding to a first unit area Unit including the second electrode 191b. In addition, when the first-step driving signal is applied to the first and second electrodes 191a and 191b and the upper electrode 290, an electric field in a region S2 adjacent to the first plate 100 is weaker than an electric field in a region D2 adjacent to the second plate 200 in a liquid crystal layer 3 of a second unit area Unit including the first electrode 191a.

Referring to FIG. 14, the voltages applied to the first electrode 191a and the second electrode 191b disposed in two adjacent unit areas, respectively, may be different from each other, and thus, the electric field in the region S2 adjacent to the first electrode 191a may be weaker than the electric field in the region D1 adjacent to the second electrode 191b. To this end, as shown in FIG. 10, the voltage applied to the second electrode 191b may be greater than the voltage applied to the first electrode 191a. The upper electrode 290 may be applied with a voltage that is different from the voltages applied to the first and second electrodes 191a and 191b. For example, a voltage that is smaller than the voltages applied to the first and second electrodes 191a and 191b may be applied to the upper electrode 290.

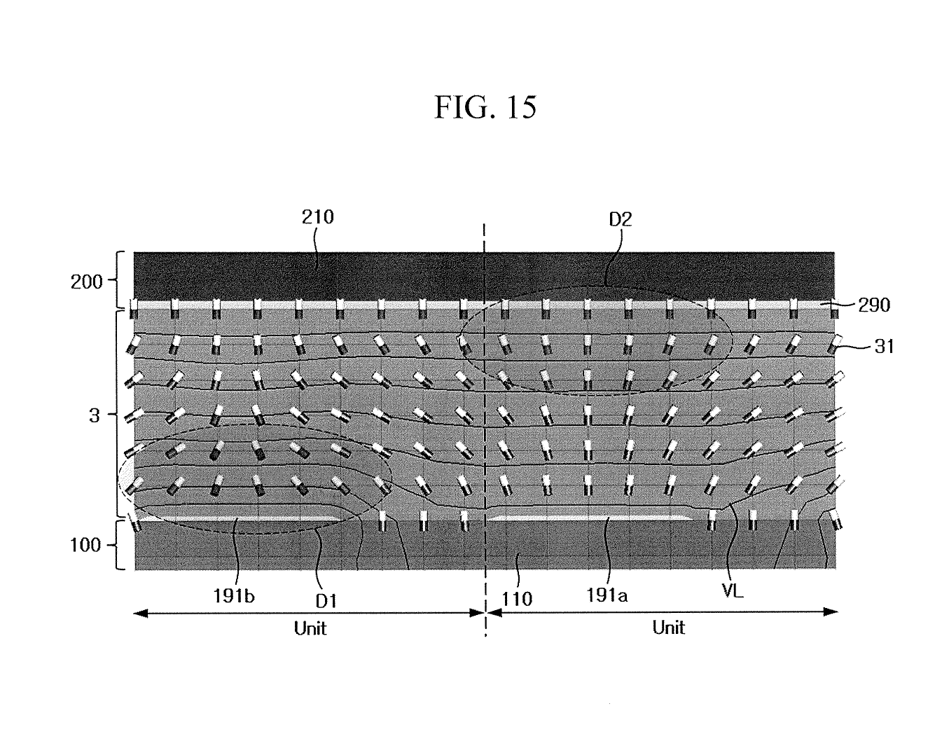

FIG. 15 is a cross-sectional view showing an arrangement of liquid crystal molecules 31 before being stabilized after a first-step driving signal is applied to an optical modulation device according to an exemplary embodiment of the present invention, which is taken along a plane IV shown in FIG. 9. The liquid crystal molecules 31 may react to an electric field E generated to a liquid crystal layer 3 when the first-step driving signal is applied to the optical modulation device. As described above, in the liquid crystal layer 3 corresponding to the first unit including the second electrode 191b, the electric field in the region D1 adjacent to the second electrode 191b may be stronger than the electric field in the region S1 adjacent to the upper electrode 290 and thus, a direction in which the liquid crystal molecules 31 of the region D1 are inclined may determine an in-plane arrangement direction of the liquid crystal molecules 31 corresponding to the second electrode 191b. For example, in the region corresponding to the second electrode 191b, the liquid crystal molecules 31 are inclined in an initial pretilt direction of the liquid crystal molecules 31 adjacent to the first plate 100 to form an in-plane arrangement of the liquid crystal molecules 31.

In addition, in the liquid crystal layer 3 corresponding to the second unit including the first electrode 191a, the electric field in the region D2 adjacent to the upper electrode 290 opposite to the first electrode 191a may be stronger than the electric field in the region S2 adjacent to the first electrode 191a, and thus, a direction in which the liquid crystal molecules 31 of the region D2 are inclined may determine an in-plane arrangement direction of the liquid crystal molecules 31. For example, in the region corresponding to the first electrode 191a, the liquid crystal molecules 31 are inclined in an initial pretilt direction of the liquid crystal molecules 31 adjacent to the second plate 200 to form an in-plane arrangement thereof. The initial pretilt direction of the liquid crystal molecules 31 adjacent to the first plate 100 in the first unit including the second electrode 191b may be opposite to the initial pretilt direction of the liquid crystal molecules 31 adjacent to the second plate 200 in the second unit including the first electrode 191a. Thus, the inclined direction of the liquid crystal molecules 31 corresponding to the first electrode 191a is opposite to the inclined direction of the liquid crystal molecules 31 corresponding to the second electrode 191b.

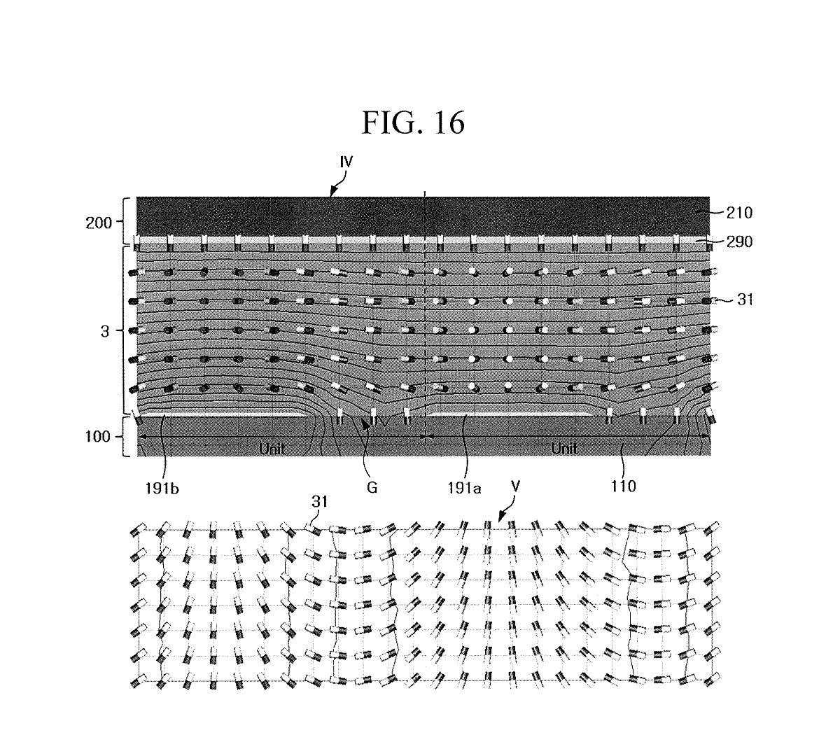

FIG. 16 are cross-sectional views showing an arrangement of liquid crystal molecules that are stabilized after a first-step driving signal is applied to an optical modulation device according to an exemplary embodiment of the present invention, which are taken along planes IV and V shown in FIG. 9. The in-plane arrangement direction of the liquid crystal molecules 31 corresponding to the first electrode 191a is substantially opposite to the in-plane arrangement direction of the liquid crystal molecules 31 corresponding to the second electrode 191b, and the liquid crystal molecules 31 corresponding to the space G between the adjacent first electrode 191a and second electrode 191b are continuously rotated along the x-axis direction to form a spiral arrangement.

The liquid crystal layer 3 of the active area AA of the optical modulation device may provide a phase retardation that is changed along the x-axis direction for the incident light.

Referring to FIG. 16, a region where the liquid crystal molecules 31 are rotated along the x-axis direction by 180 degrees is defined as one unit area Unit, and one unit area Unit may include a space G between a first lower electrode 191a and a second lower electrode 191b adjacent to the first lower electrode 191a. For example, when a right-circularly-polarized light is incident to the active area AA of the optical modulation device forming a forward phase slope according to an exemplary embodiment of the present invention, a phase change of light incident to the optical modulation device varies depending on a position of the x-axis direction. The right-circularly-polarized light may be changed into a left-circularly-polarized through the optical modulation device. A phase retardation value of the liquid crystal layer 3 is different depending on a position of the x-axis direction, and thus, the phase of the emitted circularly-polarized light may be continuously changed, for example, in the x-axis direction.

A method for realizing a reverse phase slope by using an optical modulation device according to an exemplary embodiment of the present invention will be described with reference to FIG. 10 to FIG. 12 and FIG. 17 and FIG. 18 along with the above-described drawings.

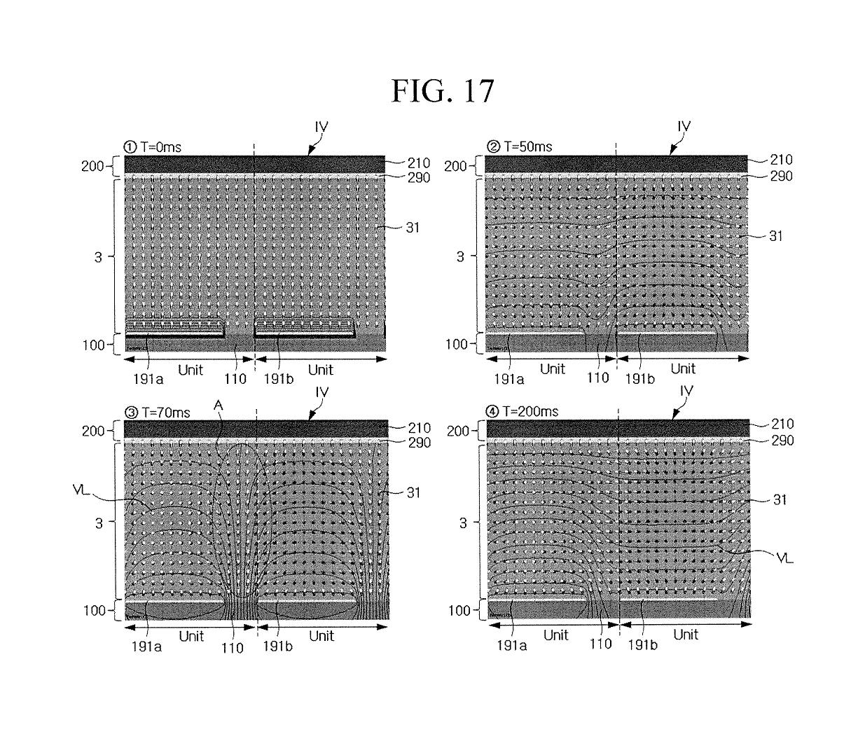

Referring to a left-upper view of FIG. 17, when no voltage is applied to the first and second electrodes 191a and 191b and the upper electrode 290, the liquid crystal molecules 31 are initially aligned in a direction substantially vertical to the surfaces of the first plate 100 and the second plate 200 and may be pretilted along the alignment directions of the first plate 100 and the second plate 200, as described above.

Referring to FIG. 10, in the optical modulation device according to an exemplary embodiment of the present invention, when the lower electrodes 191a and 191b and the upper electrode 290 are applied with the first-step driving signal and a predetermined time (e.g., 50 ms) elapses, the lower electrodes 191a and 191b and the upper electrode 290 may be applied with a second-step driving signal.

In the second step (step 2), the adjacent first electrode 191a and second electrode 191b may be applied with voltages of opposite polarities with reference to a voltage applied to the upper electrode 290. For example, the first electrode 191a may be applied with a voltage of −6 V and the second electrode 191b may be applied with a voltage of 6 V with reference to the voltage of the upper electrode 290, and vice versa.

As shown in a left-lower view of FIG. 17, equipotential lines VL are formed in the liquid crystal molecules 31, and the liquid crystal molecules 31 of an area A corresponding to a space G between the first and second electrodes 191a and 191b are arranged in a direction substantially vertical to the surfaces of the substrates 100 and 200, and an in-plane spiral arrangement is not formed in, for example, the space G.

A period of the second step (step 2) may be, for example, 20 ms, but the present invention is not limited thereto.

In an exemplary embodiment of the present invention, each unit area Unit may include a plurality of lower electrodes 191. In this case, the plurality of lower electrodes 191 of each unit area Unit may be applied with substantially the same voltages, or voltages that sequentially change by a unit of at least one lower electrode 191 may be applied to the plurality of lower electrodes 191 in each unit area Unit. The voltages applied to the respective lower electrodes 191 of the adjacent unit areas Unit may have the opposite polarities to each other with reference to the voltage of the upper electrode 290. In addition, the polarities of the voltages applied to the lower electrodes 191 may be reversed by a unit of at least one frame.

Next, in the optical modulation device according to an exemplary embodiment of the present invention, when the lower electrodes 191a and 191b and upper electrode 290 are applied with the second-step driving signal and a predetermined time (e.g., 20 ms) lapses, the lower electrodes 191a and 191b and upper electrode 290 may be applied with a third-step driving signal, which may be maintained during the rest of the period of a corresponding.

In the third step (step 3), voltage levels applied to the lower electrodes 191a and 191b and the upper electrode 290 are similar to those in the first step (step 1), however the respective relative magnitudes of the voltages applied to the first electrode 191a and the second electrode 191b may be exchanged with each other. For example, when a voltage applied to the first electrode 191a is smaller than a voltage applied to the second electrode 191b in the first step (step 1), a voltage applied to the first electrode 191a may be greater than a voltage applied to the second electrode 191b in the third step (step 3). For example, in the third step (step 3), the first electrode 191a may be applied with 10 V, the second electrode 191b may be applied with 6 V, and the upper electrode 290 may be applied with 0 V.

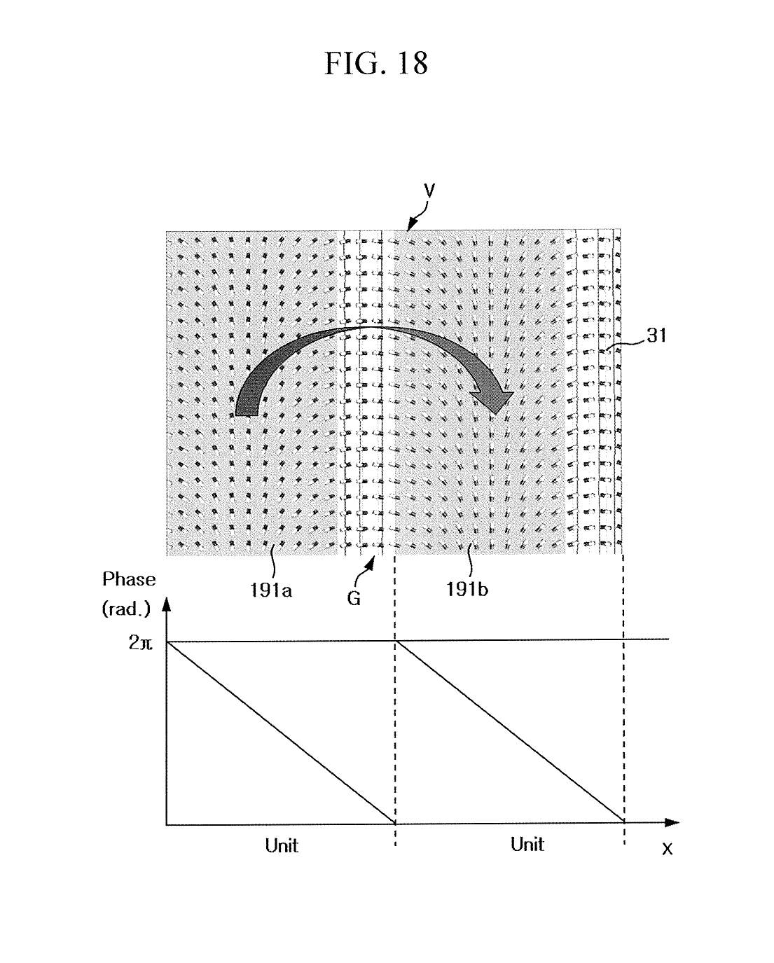

Thus, as shown in a right-lower view of FIG. 17, the liquid crystal molecules 31 are rearranged depending on an electric field generated in the liquid crystal layer 3. For example, the liquid crystal molecules 31 are mainly inclined to be substantially parallel to the surface of the first plate 100 or the second plate 200 to form an in-plane arrangement. For example, the long axis of the liquid crystal molecules 31 are rotated in an in-plane manner such that a spiral arrangement is formed as shown in FIG. 18, and thus, an “n”-shaped arrangement may be formed. Azimuthal angles of the long axes of the liquid crystal molecules 31 may be changed substantially from 180° to 0° on a cycle of a pitch of the lower electrode 191. A portion where the azimuthal angles of the long axes of the liquid crystal molecules 31 are changed substantially from 180° to 0° may form an n-shaped arrangement alignment of the liquid crystal molecules 31.

A predetermined time may be taken until the arrangement of the liquid crystal molecules 31 is stabilized after the optical modulation device is applied with the third-step driving signal, and the optical modulation device forming the reverse phase slope may be continually applied with the third-step driving signal.

As described above, when the optical modulation device satisfies Equation 1 and substantially acts as a half-wavelength plate, a rotation direction of a circularly-polarized light, which is incident to the optical modulation device, may be reversely changed. FIG. 18 shows a phase change depending on a position of the x-axis direction when a right-circularly-polarized light is incident to the active area AA of the optical modulation device. The right-circularly-polarized light passing through the active area AA of the optical modulation device may be changed into the left-circularly-polarized light. Since a phase retardation value of the liquid crystal layer 3 varies in the x-axis direction, a phase of the emitted circularly-polarized light may continuously be changed.

When an optical axis of the optical modulation device 1 acting as a half-wavelength plate is rotated by y degrees on the in-plane, a phase of the light passing through the half-wavelength plate is changed by 2φ degrees. Thus, as shown in FIG. 18, a phase of the light emitted from one unit area Unit of the optical modulation device is changed from 2π radians to 0 in the x-axial direction. This is referred to as a reverse phase slope. The one unit area may be an area in which the azimuthal angles of the long axes of the liquid crystal molecules 31 are changed by 180 degrees. The phase change may be repeated every unit area Unit, and thus, a reverse phase slope portion of a lens changing a direction of light may be implemented by using the optical modulation device.

According to an exemplary embodiment of the present invention, an in-plane rotation angle of the liquid crystal molecules 31 may be controlled according to a method of applying a driving signal and thus, a phase of light may be variously modulated and various diffraction angles of light may be formed.

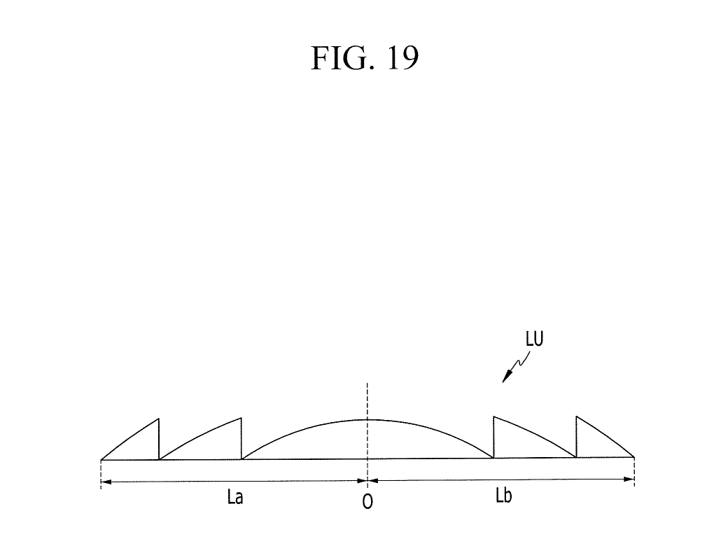

FIG. 19 is a view showing a phase change depending on a position of a lens LU realized by using an optical modulation device according to an exemplary embodiment of the present invention.

The optical modulation device according to an exemplary embodiment of the present invention may realize a forward phase slope and/or a reverse phase slope by differently applying a driving signal depending on a position of the optical modulation device to form a lens LU. FIG. 19 shows a phase change of light depending on a position of a Fresnel lens as an example of the lens LU realized by the active area AA of the optical modulation device. For example, the Fresnel lens may be a lens using an optical characteristic of a Fresnel zone plate, phase distribution of the Fresnel lens may be periodically repeated, and an effective phase delay of the Fresnel lens may be identical or similar to that of a solid convex lens or a graded-index (GRIN) lens.

As illustrated in FIG. 19, with respect to a center O of one Fresnel lens, a left portion La includes a plurality of forward phase slope areas having different widths from each other in the x-axis direction, and a right portion Lb includes a plurality of reverse phase slope areas having different widths from each other in the x-axis direction. Accordingly, a portion of the active area AA of the optical modulation device corresponding to the left portion of the lens LU may be applied with the first-step driving signal to form a forward phase slope, and a portion of the active area AA of the optical modulation device corresponding to the right portion Lb of the lens LU may be sequentially applied with the first-step driving signal, the second-step driving signal, and the third-step driving signal to form a reverse phase slope.

The forward phase slopes included in the left portion La of the lens LU may have different widths from each other depending on a position in the x axis direction, and thus, a width of a lower electrode 191 of the optical modulation device corresponding to each forward phase slope portion and/or the number of lower electrodes 191 included in one unit area Unit may be appropriately controlled. In addition, the reverse phase slopes included in the right portion Lb of the lens LU may have different widths from each other depending on a position in the axis direction, and thus, a width of a lower electrode 191 of the optical modulation device corresponding to each reverse phase slope portion and/or the number of lower electrodes 191 included in one unit area (Unit) may be appropriately controlled.

By controlling voltages applied to the lower electrode 191 and the upper electrode 290, a curvature of the phase change in the lens LU (e.g., a Fresnel lens) may be changed.

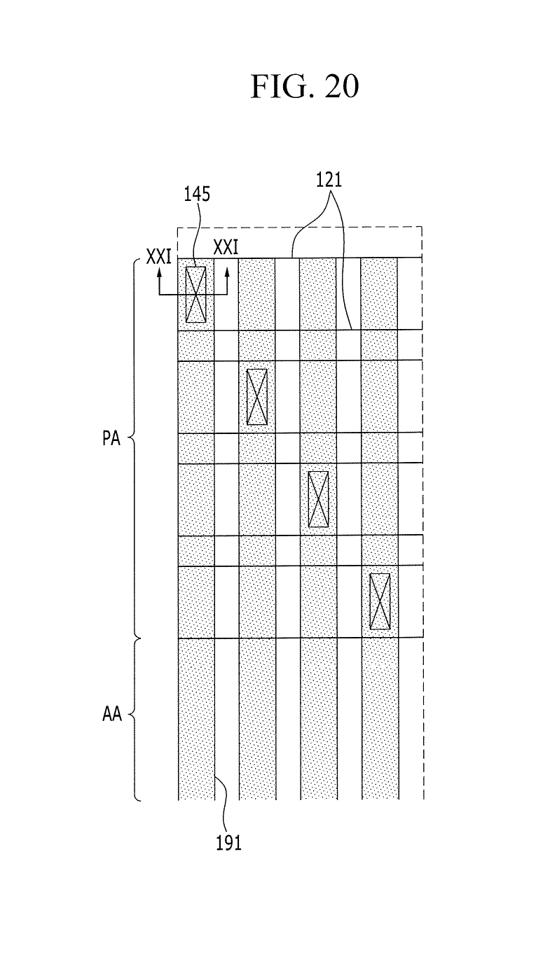

Next, a peripheral area PA of the optical modulation device according to an exemplary embodiment of the present invention will be described with reference to FIGS. 20, 21, 22(a), 22(b), and 22(c) along with the above-described drawings.

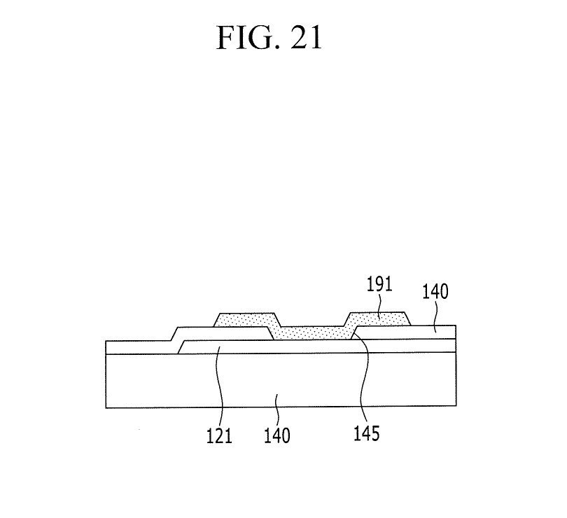

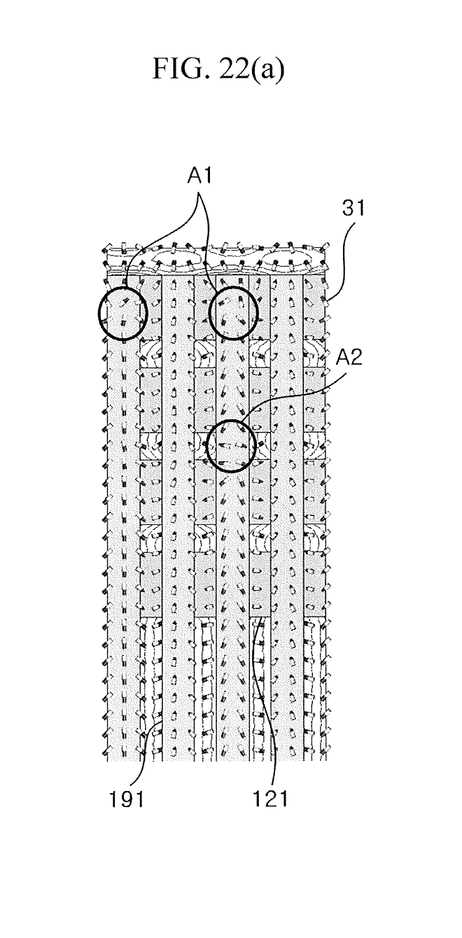

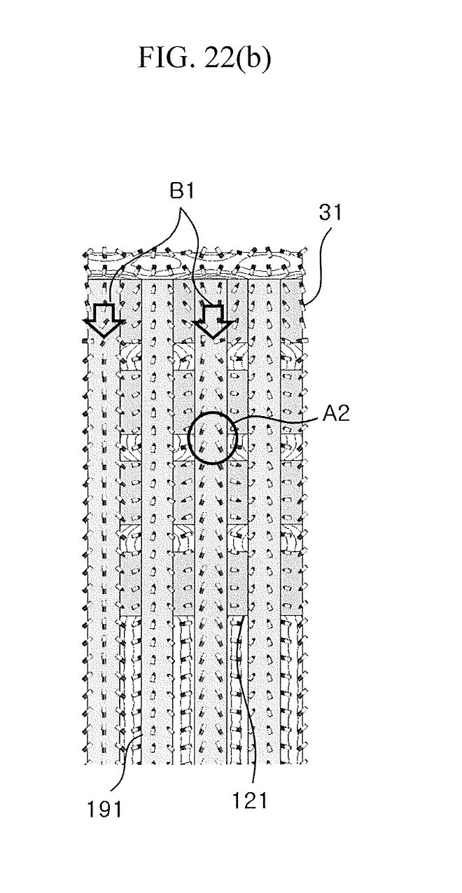

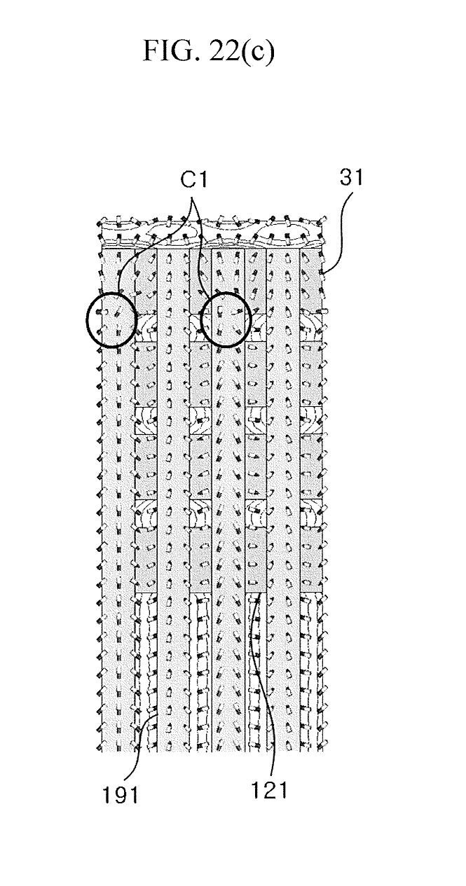

FIG. 20 is a layout view showing a peripheral area of an optical modulation device according to an exemplary embodiment of the present invention, FIG. 21 is a cross-sectional view of a peripheral area of an optical modulation device shown in FIG. 20, which is taken along a line XXI-XXI according to an exemplary embodiment of the present invention, and FIGS. 22(a) to 22(c) are layout views sequentially showing a change of an abnormal area depending on a time in which an arrangement of liquid crystal molecules generated at a peripheral area is scattered when a driving signal is applied to an optical modulation device according to an exemplary embodiment of the present invention.

Referring to FIG. 20 and FIG. 21, the plurality of lower electrodes 191, which is positioned at the active area AA of the optical modulation device according to an exemplary embodiment of the present invention and controls an spiral arrangement of the liquid crystal molecules 31, may extend to a peripheral area PA of the optical modulation device, and thus, the plurality of lower electrodes 191 may form an end and may be connected to a plurality of voltage transmitting lines 121 to receive driving voltages. FIG. 20 shows a portion of a peripheral area PA positioned at one side with respect to the active area AA, however the present invention is not limited thereto, the lower electrodes 191 may extend to the peripheral area PA positioned at both sides of the active area AA to receive the driving voltages at both sides.

Referring to FIG. 20 and FIG. 21, the plurality of voltage transmitting lines 121 is positioned on the first substrate 110 in which the plurality of lower electrodes 191 is positioned.

The voltage transmitting lines 121 transmit driving voltages to be applied to the lower electrodes 191. Different voltage transmitting lines 121 may transmit different driving voltages. The voltage transmitting lines 121 extend in a direction crossing a direction in which the lower electrodes 191 extend. For example, when the lower electrodes 191 extend in a substantially vertical direction, the voltage transmitting lines 121 may extend in a substantially horizontal direction. An extending direction of each lower electrode 191 and an extending direction of each voltage transmitting line 121 may form a right angle, or an acute angle. For example, when each lower electrode 191 is inclined with an inclination angle with respect to each vertical direction as described above, the lower electrode 191 and the voltage transmitting line 121 may form an acute angle.

The voltage transmitting lines 121 may be separated from each other and may be sequentially arranged. Each of the voltage transmitting line 121 may include a metal such as aluminum (Al), copper (Cu), alloys of the aluminum (Al), copper (Cu), or the like.

An insulating layer 140 is positioned on the voltage transmitting line 121. The insulating layer 140 may include an inorganic insulating material, an organic insulating material, or the like. The insulating layer 140 includes a contact hole 145 exposing each voltage transmitting line 121.

The lower electrodes 191 are positioned on the insulating layer 140. The lower electrode 191 is connected to each voltage transmitting line 121 through the contact hole 145 to receive the driving voltage.

A deposition sequence of the voltage transmitting line 121 and the lower electrode 191 may be exchanged.

According to an exemplary embodiment of the present invention, a lower electrode 191 connected to a voltage transmitting line 121 positioned at a middle of the plurality of voltage transmitting lines 121 may further extend outward to include a portion covering a voltage transmitting line 121 positioned outside. For example, the outward may be understood as a direction that is far from the active area AA.

For example, a lower electrode 191 connected to a voltage transmitting line 121 at an outermost position may include a portion covering the outermost voltage transmitting line 121 and a portion covering at least one voltage transmitting line 121 adjacent to the outermost voltage transmitting line 121. Accordingly, an end of the lower electrodes 191 may overlap the voltage transmitting line 121 positioned outermost.

In this case, the lower electrode 191 and the voltage transmitting line 121 overlapping each other may be insulated from each other through the insulating layer 140.

In the exemplary embodiment of the present invention as shown in FIG. 20, each of the lower electrodes 191 may overlap all the voltage transmitting lines 121.

If a lower electrode 191 has a structure that only includes a portion overlapping a voltage transmitting line 121 connected to the lower electrode 191 and does not extend to cover the voltage transmitting line 121, a spiral arrangement of the liquid crystal molecules 31 may be scattered by a fringe field due to an edge side of the voltage transmitting line 121 such that an abnormal area may be generated, and the abnormal area may be propagated along an extension direction of a lower electrode 191 adjacent to the abnormal area such that the active area AA may be affected. For example, in the peripheral area PA, the abnormal area may be small such that intensity of the an electric field formed in the abnormal area may be relatively strong, and thus, the scattered arrangement of the liquid crystal molecules 31 might not be reinstated and may be easily transmitted to the active area AA. In this case, the optical modulation device may generate a normal phase modulation to be not normally operated.

According to an exemplary embodiment of the present invention, each lower electrode 191 is not limited to a voltage transmitting line 121 connected to the lower electrode 191 and extends to the outermost voltage transmitting line 121 to cover most of the voltage transmitting lines 121, and thus, the fringe field due to the edge side of the voltage transmitting line 121 may be prevented from affecting the liquid crystal molecules 31 in an area where the lower electrode 191 extends, and an arrangement of the liquid crystal molecules 31 may be controlled by the lower electrode 191. This will be described with reference to FIGS. 22(a) to 22(c).

Referring to FIG. 22(a), in the peripheral area PA, a generation frequency of the abnormal area A1 may be reduced due to a partially scattered arrangement of the liquid crystal molecules 31 near an edge side of each voltage transmitting line 121, and although the abnormal area A1 is generated, the abnormal area A1 might not be spread as shown by an arrow B1 of FIG. 22(b), but may be stagnant like the abnormal area C1 shown in FIG. 22(c). Although another abnormal area A2 is generated as shown in FIGS. 22(a) and 22(b), the abnormal area A2 may disappear as shown in FIG. 22(c).

Accordingly, in an optical modulation device according to an exemplary embodiment of the present invention, although an arrangement of the liquid crystal molecules 31 is scattered due to the structure of the peripheral area PA to collide with normally arranged liquid crystal molecules to generate an abnormal area, the spread of the abnormal area into the active area AA may be blocked, or generation of the abnormal area may be fundamentally blocked, and thus, failure of the optical modulation device may be reduced.

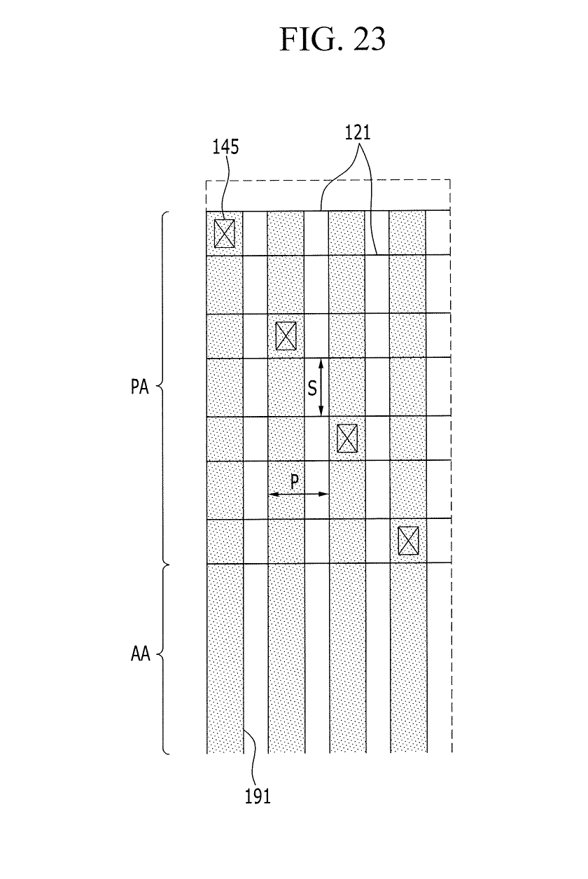

Next, a peripheral area PA of an optical modulation device according to an exemplary embodiment of the present invention will be described with reference to FIGS. 23, 24, 25(a), and 25(b) along with the above-described drawings.

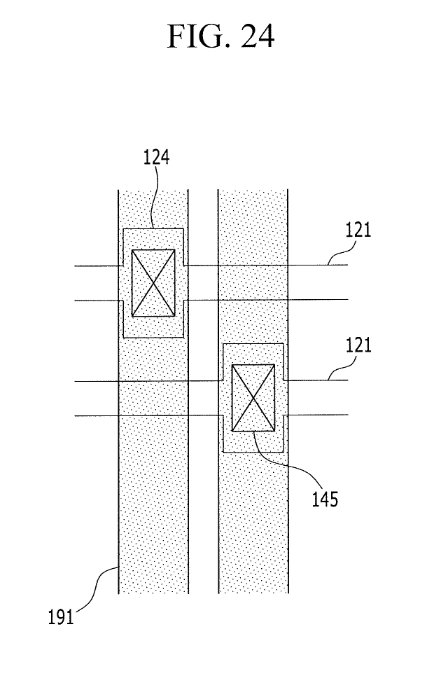

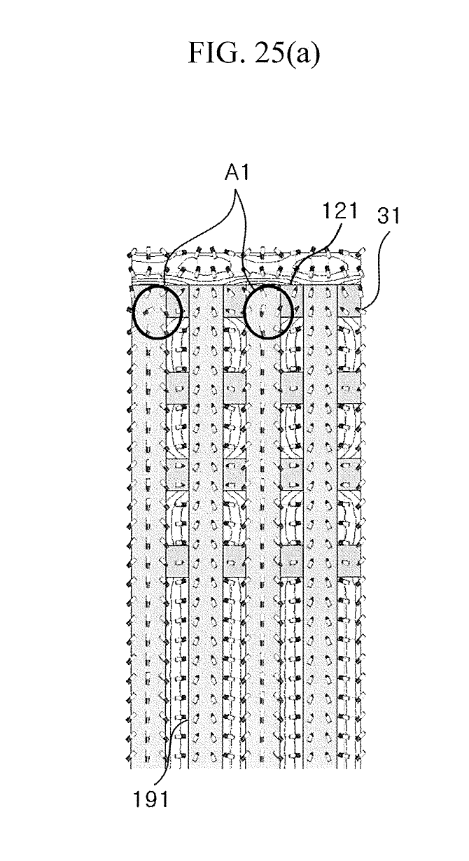

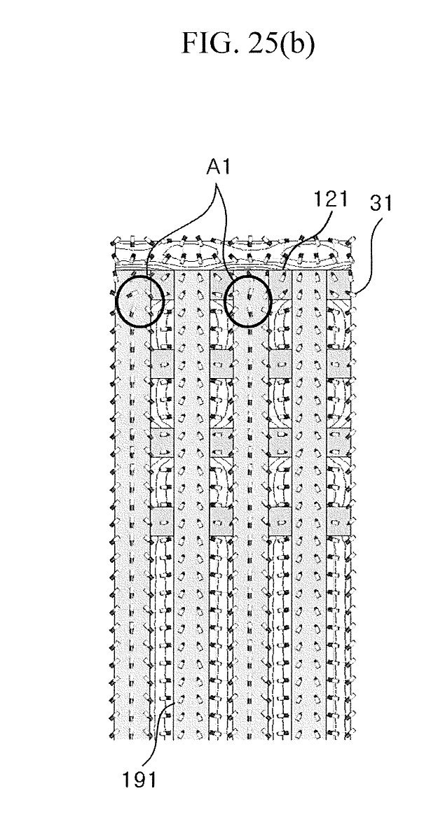

FIG. 23 is a layout view showing a peripheral area of an optical modulation device according to an exemplary embodiment of the present invention, FIG. 24 is an enlarged layout view of a portion of the peripheral area of the optical modulation device shown in FIG. 23 according to an exemplary embodiment of the present invention, and FIGS. 25(a) and 25(b) are plan views sequentially showing a change of an abnormal area depending on a time in which an arrangement of liquid crystal molecules generated at a peripheral area is scattered when a driving signal is applied to an optical modulation device according to an exemplary embodiment of the present invention.

Referring to FIG. 23 and FIG. 24, the peripheral area PA of the optical modulation device according to an exemplary embodiment of the present invention is substantially the same as those of the exemplary embodiments described above with reference to FIGS. 20, 21, and 22(a), 22(b), 22(c) except for a structure of each voltage transmitting line 121.

According to an exemplary embodiment of the present invention, an interval S between the adjacent voltage transmitting lines 121 may be equal to or more than about 80% of a pitch P of the plurality of unit areas Unit. In the present exemplary embodiment, a pitch of the plurality of lower electrodes 191 and the pitch of the plurality of unit areas Unit may be substantially the same as each other, and the interval S between the adjacent voltage transmitting lines 121 may be equal to or more than about 80% of the pitch P of the plurality of lower electrodes 191.

When the unit areas Unit have different pitches from each other P like the case in which the optical modulation device 1 according to an exemplary embodiment of the present invention realizes a Fresnel lens, the interval S between the adjacent voltage transmitting lines 121 may be equal to or more than about 80% of a pitch P of a unit area Unit having the widest width.

Therefore, a vertical width of each voltage transmitting line 121 shown in FIG. 23 may be less than that of the voltage transmitting line 121 shown in FIGS. 20, 21, and 22(a), 22(b), 22(c). Accordingly, the number of liquid crystal molecules 31 of which the arrangement is scattered near the voltage transmitting line 121 of the peripheral area PA may be reduced, and thus, propagation force of the abnormal area may be weakened. This will be described with reference to FIGS. 25(a) and 25(b).

Referring to FIG. 25(a), in the peripheral area PA, although the abnormal areas A1 are generated due to the partially scattered arrangement of the liquid crystal molecules 31 positioned near the edge side of the voltage transmitting line 121, the scattered arrangement of the liquid crystal molecules 31 might not be propagated therearound and may be stagnant as shown in FIG. 22(b).

Referring to FIG. 24, a voltage transmitting line 121 is positioned at the portion connected to the lower electrode 191 and may include an expansion 124 having a wide area. A vertical width of the expansion 124 is larger than a vertical width at a portion of the voltage transmitting line 121 that does not overlap the lower electrode 191. According to an exemplary embodiment of the present invention, the lower electrode 191 may be electrically and physically connected to the expansion 124 of the voltage transmitting line 121 through the contact hole 145. Accordingly, a contact area of the voltage transmitting line 121 and the lower electrode 191 may be increased and thus, a contact resistance corresponding to the contact area may be reduced.

According to an exemplary embodiment of the present invention, differently from FIGS. 23, 24, 25(a), and 25(b), each lower electrode 191 may extend to an area where a corresponding voltage transmitting line 121 transmitted with a driving voltage is positioned and might not extend to an outer part thereof. As described above, although the lower electrode 191 does not extend to cover all voltage transmitting lines 121, if an interval S between the voltage transmitting lines 121 is equal to or more than about 80% of a pitch P of the plurality of lower electrodes 191, a generation frequency of the abnormal area and/or propagation force thereof may be reduced.

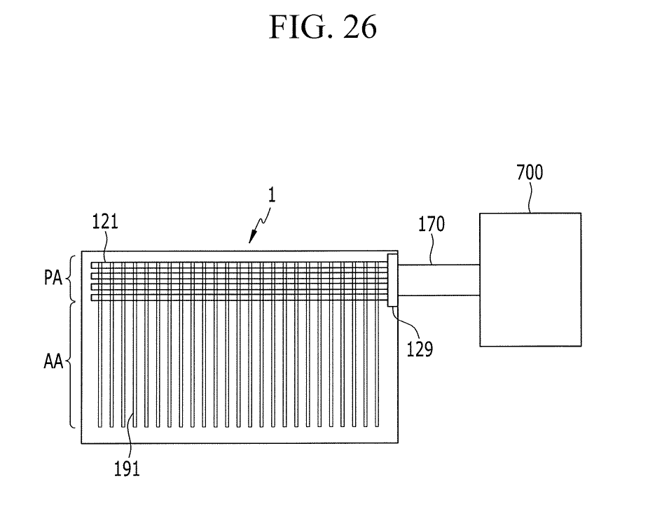

FIG. 26 is a block diagram illustrating an optical modulation device and a driver connected to the optical modulation device according to an exemplary embodiment of the present invention.

Referring to FIG. 26, an end 129 of the plurality of voltage transmitting lines 121 in the optical modulation device 1 according to an exemplary embodiment of the present invention may form a pad portion, and the pad portion is connected to a driver 700 for driving the optical modulation device 1 through wirings 170 to receive various driving signals.

While the present invention has been particularly described with reference to exemplary embodiments thereof, it will be understood that the present invention is not limited to the disclosed embodiments thereof.

What is claimed is:

1. An optical modulation device comprising:
a first plate including an active area and a peripheral area positioned around the active area;
a second plate; and
a liquid crystal layer positioned between the first plate and the second plate, the liquid crystal layer including a plurality of liquid crystal molecules,
wherein the first plate includes a first electrode, first and second voltage transmitting lines, and a first aligner,
wherein the second plate includes a second electrode and a second aligner,
wherein an alignment direction of the first aligner is substantially parallel to an alignment direction of the second aligner,
wherein the first and second voltage transmitting lines are positioned at the peripheral area and extend in a direction crossing a direction in which the first electrode extends,
wherein the first electrode is electrically connected to the first voltage transmitting line in the peripheral area,
the first electrode includes a portion overlapping the second voltage transmitting line, and
the first voltage transmitting line is positioned between the second voltage transmitting line and the active area.

2. The optical modulation device of claim 1, wherein
the first electrode includes a portion overlapping the first and second voltage transmitting lines in the peripheral area.

3. The optical modulation device of claim 2, further comprising
an insulating layer positioned between the first voltage transmitting line and the first electrode.

4. The optical modulation device of claim 3, wherein
the insulating layer includes a contact hole exposing the first electrode.

5. The optical modulation device of claim 4, wherein
the optical modulation device forms a plurality of unit areas when the first electrode and the second electrode are applied with at least one driving voltage,
a phase change of the liquid crystal layer is periodically generated by a unit of the unit area, and
an interval between the first and second voltage transmitting lines is equal to or more than substantially 80% of a pitch of the unit area.

6. The optical modulation device of claim 5, wherein
the first voltage transmitting line includes an expansion, and
the first electrode is connected to the expansion through the contact hole.

7. The optical modulation device of claim 4, wherein
when no electric field is generated to the liquid crystal layer, a pretilt direction of the liquid crystal molecules adjacent to the first plate is opposite to a pretilt direction of the liquid crystal molecules adjacent to the second plate.

8. The optical modulation device of claim 7, wherein
the plurality of unit areas includes a first unit area and a second unit area,
wherein when an electric field is generated to the liquid crystal layer, intensity of the electric field in an area adjacent to the first electrode is greater than intensity of the electric field in an area adjacent to the second electrode in a portion of the liquid crystal layer corresponding to the first electrode in the first unit area.

9. The optical modulation device of claim 8, wherein
intensity of the electric field in an area adjacent to the first plate is smaller than intensity of the electric field in an area adjacent to the second plate in a portion of the liquid crystal layer corresponding to the second unit area adjacent to the first unit area.

10. The optical modulation device of claim 7, wherein
the plurality of unit areas includes a first unit area and a second unit area adjacent to the first unit area,
wherein the first unit area includes the first electrode in the first plate, and the second unit area includes a third electrode in the first plate.

11. The optical modulation device of claim 10, wherein
a voltage applied to the first electrode included in the first unit area is greater than a voltage applied to the third electrode included in the second unit area.

12. The optical modulation device of claim 1, wherein
the optical modulation device forms a plurality of unit areas when the first electrode and the second electrode are applied with at least one driving voltage,
a phase change of the liquid crystal layer is periodically generated by a unit of the unit area, and
an interval between the first and second voltage transmitting lines is equal to or more than substantially 80% of a pitch of the unit area.

13. The optical modulation device of claim 12, wherein
the first voltage transmitting line includes an expansion, and
the first electrode is connected to the expansion.

14. An optical modulation device comprising:
a first plate including an active area and a peripheral area positioned around the active area;
a second plate; and
a liquid crystal layer positioned between the first plate and the second plate, the liquid crystal layer including a plurality of liquid crystal molecules,
wherein the first plate includes a first electrode, first and second voltage transmitting lines, and a first aligner,
wherein the second plate includes a second electrode and a second aligner,
wherein an alignment direction of the first aligner is substantially parallel to an alignment direction of the second aligner,
wherein the first and second voltage transmitting lines are positioned at the peripheral area and extend in a direction crossing a direction in which the first electrode extends,
wherein the first electrode is electrically connected to the first voltage transmitting line in the peripheral area, and
wherein when a driving voltage is applied to the first electrode and the second electrode, the optical modulation device forms a plurality of unit areas,
a phase change of the liquid crystal layer is periodically generated by a unit of the unit area, and
an interval between the first and second voltage transmitting lines is equal to or more than substantially 80% of a pitch of the unit area.

15. The optical modulation device of claim 14, wherein
the first voltage transmitting line includes an expansion, and
the first electrode is connected to the expansion.

16. The optical modulation device of claim 14, wherein
when no electric field is generated to the liquid crystal layer, a pretilt direction of the liquid crystal molecule adjacent to the first plate is opposite to a pretilt direction of the liquid crystal molecules adjacent to the second plate.

17. An optical modulation device, comprising:
a first plate including an active area and a peripheral area positioned around the active area;
a second plate; and
a liquid crystal layer positioned between the first plate and the second plate, the liquid crystal layer including a plurality of liquid crystal molecules,
wherein the first plate includes a first electrode and first and second voltage transmitting lines,
wherein the second plate includes a second electrode,
wherein the first and second voltage transmitting lines extend in a first direction crossing a second direction in which the first electrode extends,
wherein the first and second voltage transmitting lines are substantially parallel to each other,
wherein the optical modulation device forms a plurality of unit areas when the first electrode and the second electrode are applied with at least one driving voltage,
wherein a width of each of the first and second voltage transmitting lines depends on a pitch of the unit area, and
wherein the first electrode is electrically connected to the first voltage transmitting line in the peripheral area.

18. The optical modulation device of claim 17, wherein the first electrode includes a portion overlapping the second voltage transmitting line, and
the first voltage transmitting line is positioned between the second voltage transmitting line and the active area.

19. The optical modulation device of claim 17, wherein the width of each of the first and second voltage transmitting lines is decreased as the pitch of the unit area is increased.

20. The optical modulation device of claim 17, wherein
an interval between the first and second voltage transmitting lines is equal to or more than substantially 80% of the pitch of the unit area.
